(19) United States
(12) Patent Application Publication
(10) Pub. No.: US 2026/0072396 A1
(43) Pub. Date: Mar. 12, 2026

(54) IMAGE FORMING APPARATUS

(71) Applicant: CANON KABUSHIKI KAISHA, Tokyo (JP)

(72) Inventor: YOJI MISAO, Shizuoka (JP)

(21) Appl. No.: 19/323,572

(22) Filed: Sep. 9, 2025

(30) Foreign Application Priority Data
Sep. 10, 2024 (JP) 2024-156803

(51) Int. Cl. G03G 21/16; G03G 21/18

(52) U.S. Cl. CPC G03G 21/1647; G03G 21/1619; G03G 21/1638; G03G 21/1842; G03G 2221/1654; G03G 2221/1675; G03G 2221/169

(57) ABSTRACT

An image forming apparatus includes a positioning portion, a restriction portion, and a return portion. In contrast to an engagement portion provided on one of an apparatus main body and a pullout portion, an engaged portion provided on the other of the apparatus main body and the pullout portion. When the pullout portion is in an attachment position, first and second contact portions are in contact with the engagement portion. The contact between the first contact portion and the engagement portion restricts movement of the pullout portion in an insertion direction. The contact between the second contact portion and the engagement portion restricts movement of the pullout portion in a pullout direction. The restriction portion restricts the movement of the pullout portion when the pullout portion reaches a restricted position. The return portion moves the pullout portion to the attachment position when the pullout portion is in the restricted position.

### BACKGROUND

### Field of the Technology

The present disclosure relates to a positioning device that positions a pullout portion with respect to an apparatus main body, and to an image forming apparatus including the same.

### Description of the Related Art

Some image forming apparatuses, such as printers, copiers, and multi-function peripherals, are configured to removably mount cartridges on a tray (pullout portion) that moves between the inside and the outside of the apparatus main body, the cartridges being formed by integrally incorporating a photosensitive drum and a process unit that acts on the photosensitive drum. Conventionally, image forming apparatuses have been proposed in which an engagement portion is provided on one of the apparatus main body and the tray while an engaged portion is provided on the other thereof, and in which the engagement between the engagement portion and the engaged portion allows for the positioning of the tray in the attachment direction.

When at least one of the engagement portion and the engaged portion deforms, the position of the tray with respect to the apparatus main body varies.

### SUMMARY

The present disclosure is directed to provide a technology capable of suppressing the influence on the positioning of a tray with respect to an apparatus main body caused by the deformation of at least one of an engagement portion and an engaged portion.

To solve the above problem, an image forming apparatus configured to perform an image forming operation on a recording material according to the present disclosure includes:
an apparatus main body;
a pullout portion movable with respect to the apparatus main body in an insertion direction and a pullout direction opposite to the insertion direction, the pullout portion being movable with respect to the apparatus main body to an attachment position, a pullout position located downstream of the attachment position in the pullout direction, and a restricted position located downstream of the attachment position in the insertion direction;
an engagement portion provided on one of the apparatus main body and the pullout portion; and
an engaged portion provided on the other of the apparatus main body and the pullout portion,
wherein
the engaged portion includes
   a positioning portion including a first contact portion and a second contact portion, the first contact portion and the second contact portion of the positioning portion being in contact with the engagement portion in a case where the pullout portion is in the attachment position, movement of the pullout portion in the insertion direction is restricted by contact between the first contact portion and the engagement portion, movement of the pullout portion in the pullout direction is restricted by contact between the second contact portion and the engagement portion,
   a restriction portion configured to contact the engagement portion to restrict the movement of the pullout portion in the insertion direction in a case where the pullout portion reaches the restricted position, and
   a return portion configured to contact the engagement portion in a case where the pullout portion is in the restricted position so that the pullout portion moves from the restricted position to the attachment position under an own weight thereof.

Features of the present disclosure will become apparent from the following description of embodiments with reference to the attached drawings. The following description of embodiments is described by way of example.

### BRIEF DESCRIPTION OF THE DRAWINGS

FIG. 1 is a view illustrating the overall configuration of the image forming apparatus according to a first embodiment;

FIG. 2 is a view illustrating the image forming apparatus with the door opened;

FIG. 3 is a view illustrating the image forming apparatus in a state in which the fixing device has moved;

FIG. 4 is a view illustrating the image forming apparatus in a state in which the transfer unit and the tray unit have been pulled out;

FIG. 5 is a view illustrating the image forming apparatus in a state in which the transfer unit has been pulled out alone;

FIG. 6 is a view illustrating the movement of the transfer unit and the tray unit according to the first embodiment;

FIG. 7 is a view illustrating the movement of the transfer unit and the tray unit according to the first embodiment;

FIG. 8 is a view illustrating the connection member that connects the tray and the transfer unit according to the first embodiment;

FIG. 9 is a view illustrating the connection member that connects the tray and the transfer unit according to the first embodiment;

FIG. 10A is a view illustrating a state in which both the first contact portion and the second contact portion are in contact with the connection shaft in the positioning of the tray unit and the apparatus main body according to the first embodiment;

FIG. 10B is a view illustrating a state in which both the third contact portion is in contact with the connection shaft in the positioning of the tray unit and the apparatus main body according to the first embodiment;

FIG. 11 is a view illustrating the positioning of the tray unit and the apparatus main body according to the first embodiment;

FIG. 12 is a cross-sectional upper surface view of the apparatus main body;

FIG. 13 is a view illustrating the tray handle of the tray unit according to a second embodiment;

FIG. 14A is a view illustrating a state in which both the tray shaft is in contact with both the first contact portion and the second contact portion in the positioning of the tray unit and the apparatus main body according to the second embodiment;

FIG. 14B is a view illustrating a state in which the tray shaft is in contact with the third contact portion in the positioning of the tray unit and the apparatus main body according to the second embodiment;

FIG. 15 is a view illustrating the positioning of the tray unit and the apparatus main body according to the second embodiment;

FIG. 16 is a view illustrating the positioning of the tray unit and the apparatus main body according to a third embodiment;

FIG. 17 is a view illustrating the positioning of the tray unit and the apparatus main body according to a fourth embodiment;

FIG. 18A is a view illustrating a state in which, in the configuration of the engagement portion and the engaged portions according to the first embodiment, the third contact portion provided on the tray unit is in contact with the connection shaft provided on the apparatus main body, and in which the tray unit is in the restricted position;

FIG. 18B illustrates a state in which, in the configuration of the engagement portion and the engaged portions according to the first embodiment, the first contact portion and the second contact portion provided on the tray unit are in contact with the connection shaft provided on the apparatus main body, and in which the tray unit is in the attachment position;

FIG. 19A illustrates a state in which, in the configuration of the engagement portion and the engaged portions according to the second embodiment, the tray shaft provided on the tray unit is in contact with the third contact portion provided on the apparatus main body, and in which the tray unit is in the restricted position; and

FIG. 19B illustrates a state in which, in the configuration of the engagement portion and the engaged portions according to the second embodiment, the tray shaft provided on the apparatus main body is in contact with the first contact portion and the second contact portion provided on the tray unit, and in which the tray unit is in the attachment position.

### DESCRIPTION OF THE EMBODIMENTS

Hereinafter, with reference to the drawings, modes for implementing the present disclose will be exemplarily described in detail on the basis of embodiments. However, the dimensions, materials, shapes, relative arrangements, and the like of the components described in the embodiments may be appropriately modified in accordance with the configurations and various conditions of apparatuses to which the present disclosure is applied. That is, the scope of the present disclose is not intended to be limited to the following embodiments. Furthermore, all the features described in the following embodiments are not necessarily essential to the disclosed solution.

### First Embodiment

### Overall Configuration

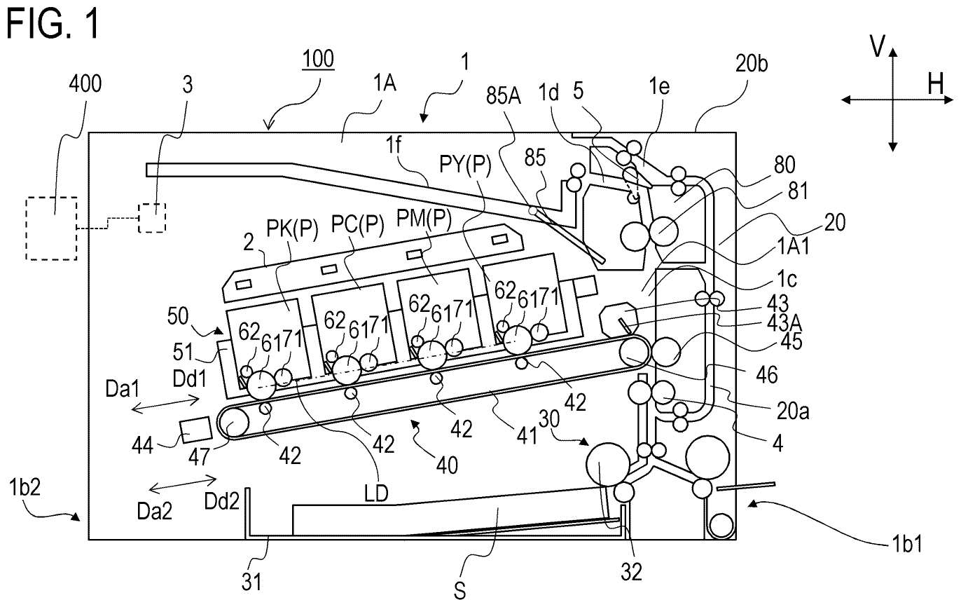

With reference to FIG. 1, a printer 1 used as an image forming apparatus will be described. FIG. 1 is a view illustrating the overall configuration of the printer 1 according to this embodiment. In this embodiment, the printer 1 is an electrophotographic color laser beam printer that forms images on sheets S used as recording materials.

The printer 1 has an apparatus main body (housing) 1A, a scanner (exposure device) 2, a control portion 3, and a door (opening and closing member) 20 that is openable and closable with respect to the apparatus main body 1A. In addition, the printer 1 also has a sheet feeding portion 30, a transfer unit (transfer device) 40, a tray unit (a movement unit or a support unit) 50, and a fixing device 80. A portion including the apparatus main body 1A and the door 20 may also be referred to as a main frame 100. The main frame 100 includes an exterior portion of the printer 1.

The apparatus main body 1A accommodates the scanner 2, the control portion 3, the sheet feeding portion 30, the transfer unit 40, the tray unit 50, and the fixing device 80. The sheet feeding portion 30 has a sheet stacking tray 31 for stacking sheets S as recording materials, and a supply roller 32. The sheet stacking tray 31 may be pulled out toward the door 20 to replenish the sheets S. The tray unit 50 has a tray (a support member or a drawer) 51 and cartridges PY, PM, PC, and PK. The tray 51 has a tray handle 52. The cartridges PY, PM, PC, and PK are attached so that they are removable from the tray 51.

Each of the cartridges PY, PM, PC, and PK is attachable to and detachable from the tray 51 independently of each other. The cartridges PY, PM, PC, and PK accommodate yellow (Y), magenta (M), cyan (C), and black (K) toner (developers), respectively. The cartridges PY, PM, PC, and PK have the same configuration, except that the toner they accommodate differs in color. Therefore, the configuration and the operation of one of the cartridges PY, PM, PC, and PK will be described, and the description of the other cartridges may be omitted. Furthermore, when the cartridges PY, PM, PC, and PK do not need to be distinguished from each other, they may be simply referred to as cartridges P. It can be said that the tray unit 50 has a plurality of cartridges P and the tray 51 to which the cartridges P are attached so that they are removable.

In this embodiment, the tray unit 50 has a plurality of photosensitive drums (image bearing members) 61, a plurality of charging rollers (charging members) 62, and a plurality of developing rollers (developer bearing members) 71. Specifically, the tray unit 50 has the four photosensitive drums 61, the four charging rollers 62, and the four developing rollers 71. The rotational axis directions of the photosensitive drums 61, the developing rollers 71, and the charging rollers 62 are parallel to each other.

The portion that forms black (K) images is referred to as a black station (first station). The photosensitive drum 61 of the first station is referred to as a first photosensitive drum, the developing roller 71 thereof is referred to as a first developing roller, and the charging roller 62 thereof is referred to as a first charging roller. The portion that forms cyan (C) images is referred to as a cyan station (second station). The photosensitive drum 61 of the second station is referred to as a second photosensitive drum, the developing roller 71 thereof is referred to as a second developing roller, and the charging roller 62 thereof is referred to as a second charging roller. The portion that forms magenta (M) images is referred to as a magenta station (third station). The photosensitive drum 61 of the third station is referred to as a third photosensitive drum, the developing roller 71 thereof is referred to as a third developing roller, and the charging roller 62 thereof is referred to as a third charging roller. The portion that forms yellow (Y) images is referred to as a yellow station (fourth station). The photosensitive drum 61 of the fourth station is referred to as a fourth photosensitive drum, the developing roller 71 thereof is referred to as a fourth developing roller, and the charging roller 62 thereof is referred to as a fourth charging roller. The cartridges PK, PC, PM, and PY are attached to the black, cyan, magenta, and yellow stations, respectively. In this embodiment, the cartridges PK, PC, PM, and PY are referred to as first, second, third, and fourth cartridges, respectively.

Note that the numbers such as “first,” “second,” “third,” and “fourth” are used merely for convenience of explanation.

The photosensitive drums 61, the charging rollers 62, and the developing rollers 71 may be provided either in the cartridges P or on the tray 51. In this embodiment, the cartridges P have the respective photosensitive drums 61, charging rollers 62, and developing rollers 71.

The transfer unit 40 has a belt 41, primary transfer rollers 42, a cleaning portion 43, a drive roller 46 that drives the belt 41, and a tension roller (driven roller) 47. In the printer 1 according to this embodiment, an optical sensor 44 is arranged to detect toner images transferred onto the belt 41. In this embodiment, the belt 41 is arranged below the photosensitive drums 61 and is capable of contacting the photosensitive drum 61 so that a primary transfer portion is formed between the belt 41 and the photosensitive drums 61. Furthermore, the printer 1 has a secondary transfer roller 45 that contacts the belt 41 so that a secondary transfer portion is formed. The secondary transfer portion is formed between the belt 41 and the secondary transfer roller 45. The rotational axis directions of the primary transfer rollers 42, the drive roller 46, the tension roller 47, and the secondary transfer roller 45 are parallel to each other. A pair of registration rollers 4 is arranged upstream of the secondary transfer portion.

The fixing device 80 has a fixing portion 81 and a flapper 5. When an image forming operation is performed on a sheet S, the fixing device 80 is in a use position. In the use position, the fixing device 80 is accommodated in (inside) the apparatus main body 1A. Furthermore, in the use position, the fixing device 80 is configured to heat the sheet S. In this embodiment, the fixing portion 81 includes a heating portion (heat roller) 82 including a heater, and a pressure portion (pressure roller) 83.

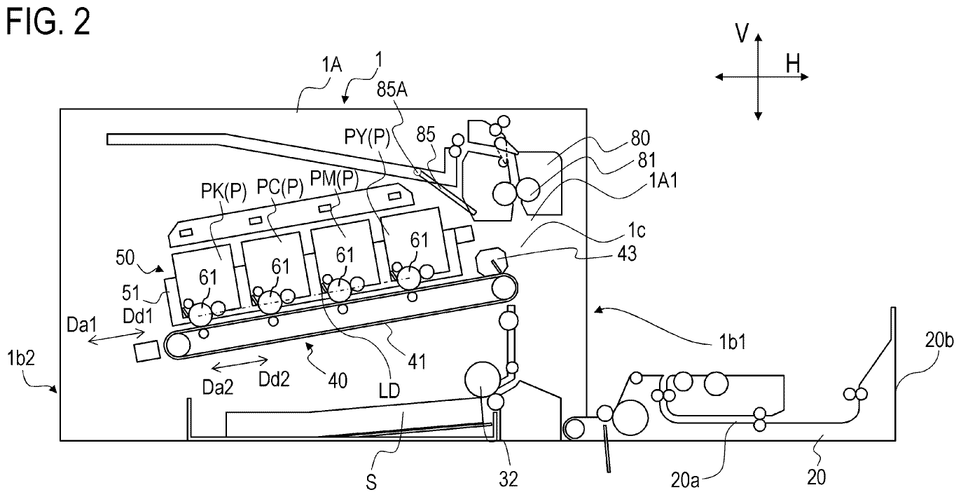

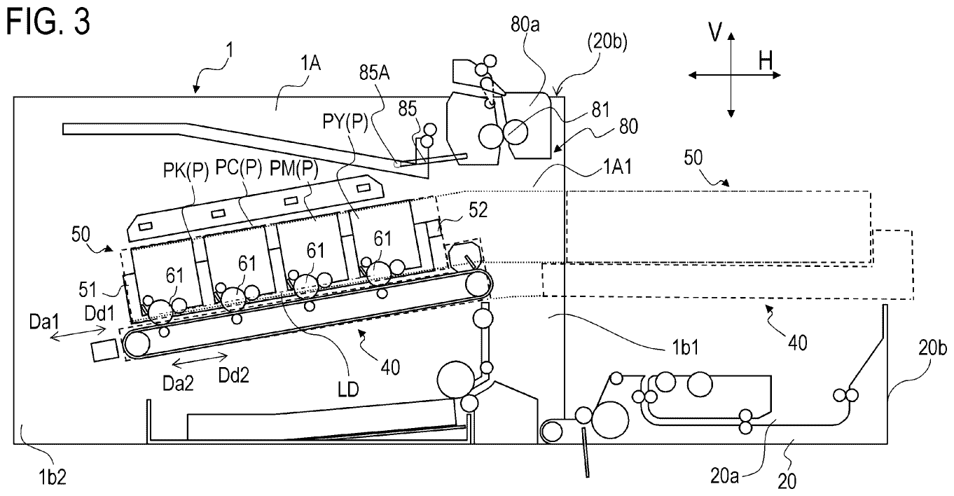

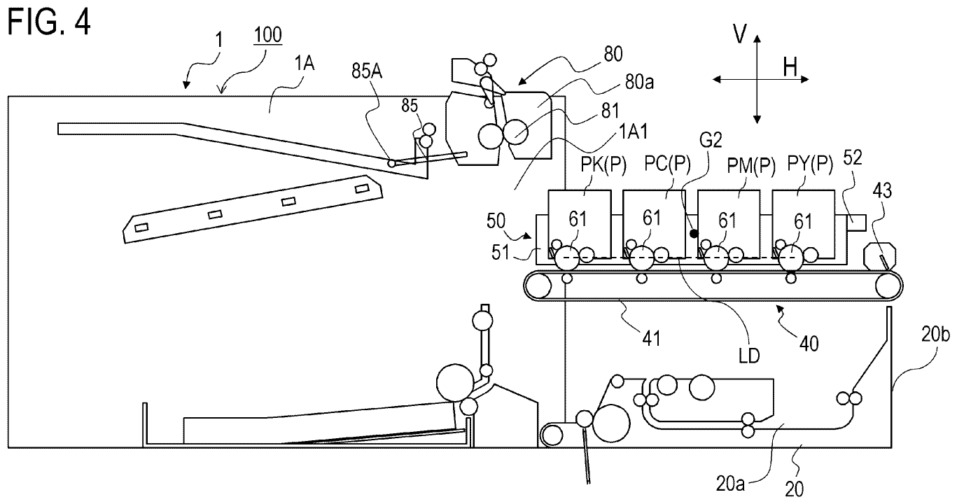

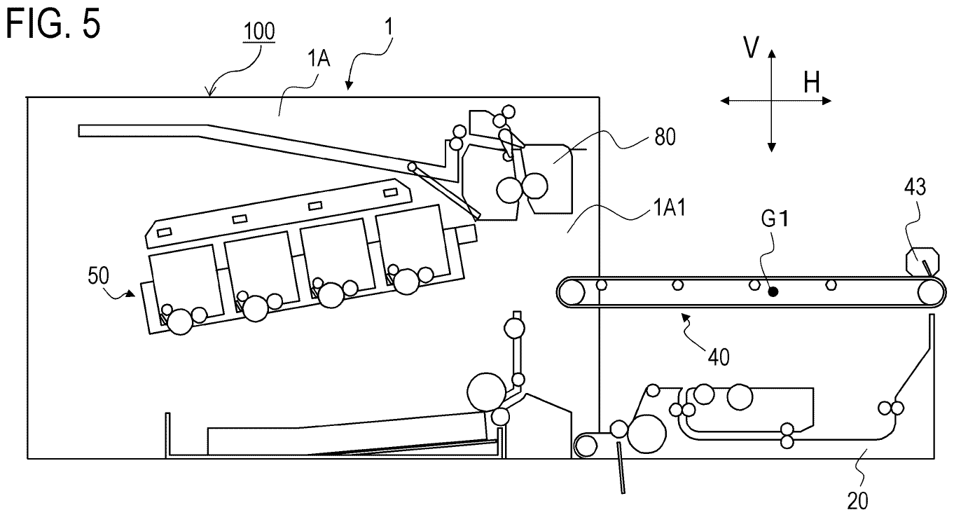

With reference to FIGS. 1, 2, 3, 4, and 5, the movement of the transfer unit 40 and the tray unit 50 will be described. FIG. 2 is a view illustrating the printer 1 with the door 20 opened. FIG. 3 is a view illustrating the printer 1 in a state in which the fixing device 80 has moved. FIG. 4 is a view illustrating the printer 1 in a state in which the transfer unit 40 and the tray unit 50 have been pulled out. FIG. 5 is a view illustrating the printer 1 in a state in which the transfer unit 40 has been pulled out alone.

The transfer unit 40 and the tray unit 50 are movable from the inside to the outside of the apparatus main body 1A. In a horizontal direction H, the apparatus main body 1A has a first end 1b1 that is provided with an opening 1A1 and a second end 1b2 that is opposite to the first end 1b1. The tray unit 50 is movable between a first inner position inside the apparatus main body 1A and a first outer position outside the apparatus main body 1A through the opening 1A1. The transfer unit 40 is movable between a second inner position inside the apparatus main body 1A and a second outer position outside the apparatus main body 1A through the opening 1A1. The opening 1A1 may include an opening through which the tray unit 50 passes and an opening through which the transfer unit 40 passes. When the transfer unit 40 moves from the second inner position to the second outer position, at least the belt 41 moves with at least a part thereof protruding outward from the apparatus main body 1A.

The direction in which the tray unit 50 moves from the first inner position to the first outer position is referred to as a tray pullout direction Dd1 (pullout direction), and the direction opposite to the tray pullout direction Dd1 is referred to as a tray attachment direction Da1 (attachment direction). It can be said that the tray pullout direction Dd1 is a direction from the second end 1b2 toward the first end 1b1.

The direction in which the transfer unit 40 moves from the second inner position to the second outer position is referred to as a transfer pullout direction Dd2, and the direction opposite to the transfer pullout direction Dd2 is referred to as a transfer attachment direction Da2. In the transfer pullout direction Dd2, the drive roller 46 is located downstream of the tension roller 47. The transfer pullout direction Dd2 is a direction from the second end 1b2 toward the first end 1b1.

The tray pullout direction Dd1 and the tray attachment direction Da1 are directions (it may be orthogonal directions) that intersect the rotational axis direction of the photosensitive drums 61. The transfer pullout direction Dd2 and the transfer attachment direction Da2 are directions (it may be orthogonal directions) that intersect the rotational axis direction of the drive roller 46. The rotational axis direction of the drive roller 46 is parallel to the rotational axis direction of the photosensitive drums 61.

In the horizontal direction H, the fixing device 80 is arranged on one end side of the apparatus main body 1A (i.e., the side where the first end 1b1 is arranged).

The door 20 attached to the apparatus main body 1A is movable between a closed position and an open position. As illustrated in FIG. 1, when the door 20 is in the closed position (closed state), it covers the opening 1A1. As illustrated in FIG. 2, when the door 20 is in the open position (open state), the opening 1A1 is exposed.

As illustrated in FIG. 1, when the door 20 is in the closed position, it covers the fixing device 80 attached to the apparatus main body 1A. More specifically, when the door 20 is in the closed position, an upper cover portion 20b of the door 20 is located above the fixing device 80. The upper cover portion 20b of the door 20 functions as a part of the exterior portion.

The door 20 is movable between the open position and the closed position when the fixing device 80 is in a state of being supported by the apparatus main body 1A. In other words, the door 20 moves from the closed position to the open position so as to separate from the fixing device supported by the apparatus main body 1A.

Accordingly, as illustrated in FIG. 2, when the door 20 is in the open position, it is separated from the fixing device 80 supported by the apparatus main body 1A.

As will be described later, the fixing device 80 is movable from the state illustrated in FIG. 2 to the state illustrated in FIG. 3 so that the opening 1A1 is widely exposed. In a state in which the door 20 and the fixing device 80 have moved (FIG. 3), the transfer unit 40 and the tray unit 50 are movable from the inside to the outside of the apparatus main body 1A through the opening 1A1. After the movement, the state illustrated in FIG. 4 is obtained.

In a state in which the tray unit 50 has moved to the outside of the apparatus main body 1A (FIG. 4), the removal of the cartridges PY, PM, PC, and PK from the tray 51 and the attachment of the cartridges PY, PM, PC, and PK to the tray 51 are allowed. As a result, the cartridges PY, PM, PC, and PK are replaceable with new cartridges PY, PM, PC, and PK, respectively. In this embodiment, the cartridges P are attachable to and detachable from the tray 51 in a direction (it may be an orthogonal direction) that intersects the rotational axes of the photosensitive drums 61.

The cartridges PY, PM, PC, and PK are removed from the tray 51 by being moved in a direction away from the transfer unit 40 with respect to the tray 51. In other words, the cartridges PY, PM, PC, and PK are removed from the tray 51 by being moved to the side opposite to the transfer unit 40 with respect to the tray 51. In this embodiment, the transfer unit 40 is arranged below the tray unit 50. Accordingly, the cartridges PY, PM, PC, and PK are removed from the tray 51 by being moved upward with respect to the tray 51.

In addition, the transfer unit 40 is removable from the apparatus main body 1A independently of the tray unit 50 and is replaceable with a new transfer unit 40.

### Image Forming Operation

With reference to FIG. 1, the image forming operation of the printer 1 will be described. The control portion 3 of the printer 1 starts the image forming operation on a sheet S on the basis of an image signal received from an external host apparatus 400.

The external host apparatus 400 is, for example, a personal computer, an image reader, a facsimile machine, or the like.

When an image is formed on the sheet S, the fixing device 80 is in the use position, the tray unit 50 is in the first inner position, the transfer unit 40 is in the second inner position, and the door 20 is in the closed position. When the transfer unit 40 is in the second inner position, the belt 41 is capable of contacting the photosensitive drums 61. At this time, the tray unit 50 is located above the transfer unit 40.

As a charging voltage is applied to the charging rollers 62, the photosensitive drums 61 rotate. A laser beam corresponding to image information is irradiated from the scanner 2 onto the photosensitive drums 61, thereby exposing the surfaces of the photosensitive drums 61 charged by the charging rollers 62. As a result, electrostatic latent images corresponding to the image information are formed on the surfaces of the photosensitive drums 61.

The developing roller 71 bears toner. A developing voltage is applied to the developing rollers 71, and the electrostatic latent images formed on the photosensitive drums 61 are developed by the toner supplied from the developing rollers 71, thereby forming toner images on the surfaces of the photosensitive drums 61. In this embodiment, the developing rollers 71 develop the electrostatic latent images while being in contact with the photosensitive drums 61. However, the developing rollers 71 may also develop the electrostatic latent images with a gap between the developing rollers 71 and the photosensitive drums 61.

When a full-color image is formed, a toner image of each color is formed on each of the photosensitive drums 61.

Note that in this embodiment, when the tray unit 50 is in the first inner position, the developing rollers 71 are movable between a contact position where they are in contact with the photosensitive drums 61 and a separated position where they are separated from the photosensitive drums 61. Specifically, a switching device provided in the apparatus main body 1A switches between a state in which the developing rollers 71 are in the contact position and a state in which the developing rollers 71 are in the separated position. As a result, in a state in which the image forming operation is not performed, the developing rollers 71 may be separated from the photosensitive drums 61.

Furthermore, the printer 1 is capable of performing mono-color printing when the developing roller 71 and the photosensitive drum 61 corresponding to the cartridge PK are in contact with each other, while the developing rollers 71 and the photosensitive drums 61 corresponding to the respective cartridges PY, PM, and PC are separated from each other. Furthermore, the printer 1 is capable of performing full-color printing when the photosensitive drums 61 corresponding to the cartridges PY, PM, PC, and PK and the belt 41 are in contact with each other.

The toner images formed on the respective photosensitive drums 61 are transferred onto the belt 41 at primary transfer portions by the primary transfer rollers 42 and are then conveyed toward a secondary transfer portion formed by the belt 41 and the secondary transfer roller 45.

Meanwhile, a conveyance passage (a first passage or a first conveyance passage) 1c, through which the sheet S heading for the fixing device 80 passes, is formed in the apparatus main body 1A. Furthermore, a double-sided conveyance passage (a second passage or a second conveyance passage) 20a, through which the sheet S having passed through the fixing device 80 passes, is formed on the door 20.

The door 20 covers the conveyance passage 1c in the closed state. When the door 20 is opened, the conveyance passage 1c and the double-sided conveyance passage 20a are exposed (FIG. 2).

In the sheet feeding portion 30, one sheet S from among the sheets S stacked in the sheet stacking tray 31 is separated and fed by the supply roller 32 at a specified timing and is conveyed toward the secondary transfer portion and the fixing device 80 through the conveyance passage 1c.

In the secondary transfer portion, the toner images are transferred from the belt 41 onto the sheet S. The toner that has not been transferred onto the sheet S is removed from the belt 41 by a cleaning blade (cleaning member) 43A provided inside the cleaning portion 43.

The sheet S, onto which the toner images have been transferred in the secondary transfer portion, is conveyed toward the fixing device 80. In the fixing device 80, the sheet S is heated and pressurized by the fixing portion 81, and the toner images are fixed onto the sheet S. The sheet S, onto which the toner images have been fixed, is conveyed toward the flapper 5 serving as a passage switching portion.

The flapper 5 is movable between a sheet discharge position where the sheet S having passed through the fixing device 80 is guided toward the sheet discharge passage 1d, and a reverse position where the sheet S is guided toward a reverse passage 1e.

When one-side printing is performed to form an image on one side of the sheet S, the sheet S is guided to the sheet discharge passage 1d by the flapper 5 and discharged onto a discharge tray 1f formed at an upper portion of the apparatus main body 1A.

On the other hand, when double-sided printing is performed to form an image on both sides of the sheet S, the sheet S is guided to the reverse passage 1e by the flapper 5. After the sheet S has been guided to the reverse passage 1e, the conveyance direction of the sheet S is reversed, and the sheet S is conveyed toward the secondary transfer portion through the double-sided conveyance passage 20a formed on the door 20. After the toner images have been transferred onto the rear surface of the sheet S in the secondary transfer portion, the sheet S passes through the fixing device 80, is guided to the sheet discharge passage 1d by the flapper 5, and is discharged onto the discharge tray 1f of the apparatus main body 1A.

### Pulling Out Tray Unit and Transfer Unit and Arrangement of Fixing Device

With reference to FIGS. 1, 2, 3, 4, and 5, the pullout of the tray unit 50 and the transfer unit 40 from the apparatus main body 1A and the arrangement of the fixing device 80 will be described.

As described above, the fixing device 80 of the printer 1 is arranged on one end side of the apparatus main body 1A in the horizontal direction. Furthermore, the transfer unit 40 and the tray unit 50 move from one end side of the apparatus main body 1A to the outside of the apparatus main body 1A through the opening 1A1.

In other words, the fixing device 80 is located closer to the first end 1b1 than to the second end 1b2 in the horizontal direction H. That is, in the horizontal direction H, the distance between the fixing device 80 and the first end 1b1 is shorter than that between the fixing device 80 and the second end 1b2. The fixing device 80 is arranged at a position closer to the first end 1b1 than to the center of the apparatus main body 1A in the horizontal direction H. It can be said that the distance between the first end 1b1 and the fixing device 80 in the horizontal direction H is shorter than that between the first end 1b1 and the center of the apparatus main body 1A.

As described above, when the tray unit 50 moves from the first inner position to the first outer position, the movement direction of the tray unit 50 is a direction that intersects the rotational axes of the photosensitive drums 61. At this time, the tray unit 50 moves away from the second end 1b2.

As described above, when the transfer unit 40 moves from the second inner position to the second outer position, the movement direction of the transfer unit 40 is a direction that intersects the rotational axis of the drive roller 46. At this time, the transfer unit 40 moves away from the second end 1b2.

As described above, the door 20 according to this embodiment covers the opening 1A1 in the closed state and also covers at least a part of the conveyance passage 1c for the sheet S. Furthermore, the door 20 includes the double-sided conveyance passage 20a. When the sheet S becomes jammed (hereinafter referred to as jam), the user of the printer 1 is able to remove the sheet S from the one end side of the apparatus main body 1A to clear the jam. Specifically, by moving the door 20 to the open position, the user is able to access the inside of the apparatus main body 1A and remove the sheet S. Furthermore, when a part of the sheet S that has passed through the fixing device 80 is exposed outside the apparatus main body 1A, the user is able to pull the sheet S from the outside of the apparatus main body 1A without opening the door 20 and remove the sheet S.

In addition, by moving the transfer unit 40 and the tray unit 50 from the one end side of the apparatus main body 1A to the outside of the apparatus main body 1A, the user of the printer 1 is able to perform operations, such as confirming the status, maintaining, or replacing the transfer unit 40 and the cartridges P.

That is, in the printer 1, the transfer unit 40 and the tray unit 50 are configured to be movable between the inside and the outside of the apparatus main body 1A through the one end side of the apparatus main body 1A, while the fixing device 80 is arranged on the one end side of the apparatus main body 1A. As a result, the user is able to clear the jam, access the fixing device 80, and operate the transfer unit 40 and the tray unit 50 from one direction.

In this embodiment, the side of the printer 1 where the door 20 is provided is defined as the front side. Accordingly, it is only necessary to secure space for performing operations, such as clearing the jam and operating the transfer unit 40 and the tray unit 50, from the front side of the printer 1. On the other hand, it is not necessary to secure space for performing these operations from the left side, the right side, the back side, and the top side of the printer 1. Accordingly, it is possible to install the printer 1 in a small space.

If the transfer unit 40 or the tray unit 50 is pulled out from the other end side of the apparatus main body 1A, it becomes necessary for the user to access both end sides of the apparatus main body 1A in order to clear a jam and pull out the transfer unit 40 or the tray unit 50. Furthermore, if one of the transfer unit 40 and the tray unit 50 is pulled out from the one end side of the apparatus main body 1A and the other thereof is pulled out from the other end side, it becomes necessary for the user to access both end sides of the apparatus main body 1A. Therefore, it becomes necessary to secure space for performing operations not only from the front side but also from the back side of the apparatus main body 1A, resulting in an increase in the installation area for the printer 1.

In addition, in this embodiment, the replenishment of the sheets S may be performed from the one end side of the apparatus main body 1A. Accordingly, it is only necessary to secure space for performing the replenishment of the sheets S from the front side of the printer 1, allowing the printer 1 to be installed in a small space.

### Relationship Between Tray Unit and Fixing Device

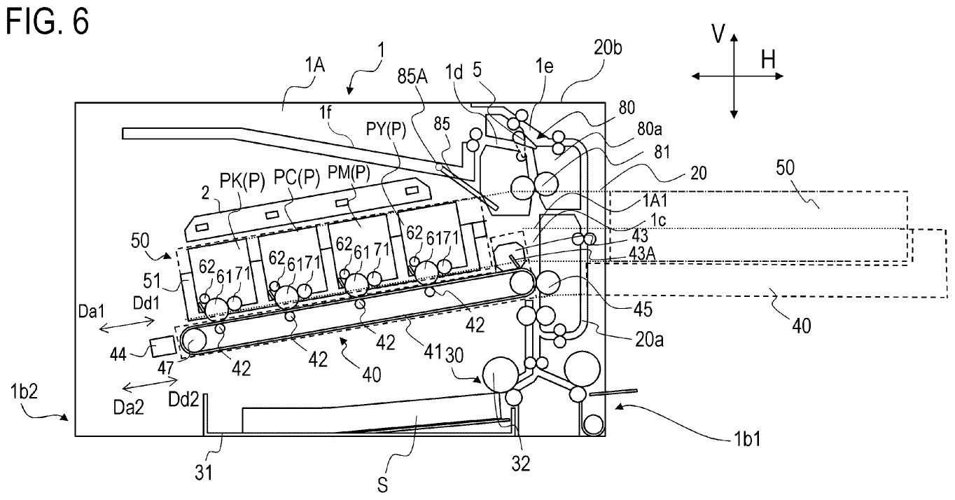

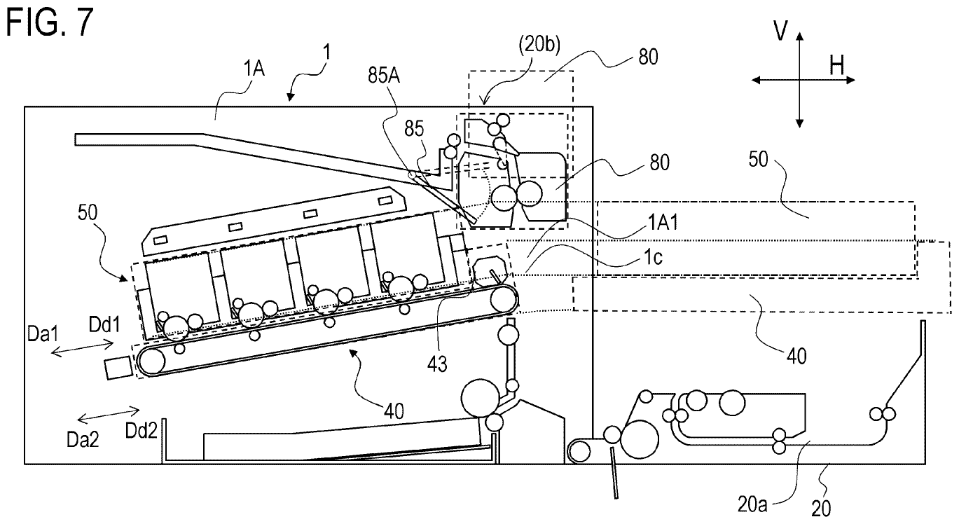

With reference to FIGS. 1, 2, 3, 4, 6 and 7, the relationship between the tray unit 50 and the fixing device 80 will be described. FIGS. 6 and 7 are views illustrating the movement of the transfer unit 40 and the tray unit 50.

The tray unit 50 passes through a specified space during the movement between the first inner position (attachment position) where an image forming operation is performed on the sheet S and the first outer position (pullout position) where the replacement of the cartridges P is allowed. The space through which the tray unit 50 passes during the movement from the first inner position to the first outer position as described above is referred to as a first space (a movement space of the tray unit 50). The first space may also be referred to as a passage or a track (a first movement passage or a first movement track) through which the tray unit 50 passes during movement from the first inner position to the first outer position.

The transfer unit 40 passes through a specified space during movement between the second inner position where an image forming operation is performed on the sheet S and the second outer position. The space through which the transfer unit 40 passes during the movement from the second inner position to the second outer position is referred to as a second space (a movement space of the transfer unit 40). The second space may also be referred to as a passage or a track (a second movement passage or a second movement track) through which the transfer unit 40 passes during the movement from the second inner position to the second outer position.

The position (use position) of the fixing device 80 when an image forming operation is performed on the sheet S has the following relationship with the first space and the second space.

That is, as illustrated in FIGS. 6 and 7, at least a part of the fixing device 80 in the use position overlaps with the first space. In other words, at least a part of the fixing device 80 is located inside the first space, while the fixing device 80 is in the use position.

In this embodiment, at least a part of the fixing device 80 overlaps with a space through which the cartridges P pass when the tray unit 50 moves from the first inner position to the first outer position. However, it may alternatively be arranged so as to overlap with a space through which the tray 51 passes.

As a result, compared to a configuration in which the fixing device 80 in the use position is located outside the first space, the miniaturization of the apparatus main body 1A is achieved.

Note that in this embodiment, at least a part of the double-sided conveyance passage 20a overlaps with the first space when the door 20 is in the closed state as illustrated in FIG. 6. That is, when the door 20 is in the closed state, at least a part of the double-sided conveyance passage 20a is located inside the first space.

As described above, at least a part of the fixing device 80 in the use position is located inside the first space. Accordingly, when the fixing device 80 is in the use position, the movement of the tray unit 50 from the first inner position to the first outer position is restricted. On the other hand, the fixing device 80 is configured to be retractable from the use position. In a state in which the fixing device 80 is retracted from the use position, the tray unit 50 is allowed to move from the first inner position to the first outer position. When the tray unit 50 moves from the first inner position to the first outer position, it passes below the fixing device 80. Note that the fixing device 80 is located outside the second space both in the use position and in the retracted position. Accordingly, when the fixing device 80 is both in the use position and in the retracted position, the transfer unit 40 is allowed to move from the second inner position to the second outer position. When the transfer unit 40 moves from the second inner position to the second outer position, it passes below the fixing device 80.

The fixing device 80 has a fixing frame body 80a that supports the fixing portion 81. When the fixing device 80 retracts from the use position, the fixing frame body 80a displaces with respect to the apparatus main body 1A while supporting the fixing portion 81.

When the tray unit 50 is pulled out to the apparatus main body 1A, the door 20 is first moved to the open position as illustrated in FIG. 2. In this embodiment, the door 20 is movable between the open position and the closed position while the fixing device 80 is located in the use position. Then, while the door 20 is in the open position, the fixing device 80 is moved from the use position to the retracted position so as to be located outside the first space as illustrated in FIG. 3.

In the printer 1 according to this embodiment, the fixing device 80 is movable between the use position and the retracted position retracted from the use position while remaining attached to the apparatus main body 1A. In this embodiment, the entire fixing device 80 is located outside the first space when it is in the retracted position.

The fixing device 80 is lifted from the use position and located at the retracted position above the use position. In other words, the retracted position is higher than the use position. As illustrated in FIG. 7, when the fixing device 80 is in the retracted position, at least a part of the fixing device 80 is in a position protruding outward from the apparatus main body 1A. In addition, when the fixing device 80 is in the retracted position, at least a part of the fixing device 80 is higher than an upper cover portion 20b of the door 20 in the closed position. As a result, in a vertical direction V, the size of the printer 1 may be kept small when the fixing device 80 is in the use position, and a space for allowing the tray unit 50 to move may be secured when the fixing device 80 moves to the retracted position. Note that when the fixing device 80 is in the retracted position, the door 20 is restricted from moving to the closed position.

Specifically, the printer 1 has a connection member (a fixing connection member, a fixing link, or an arm) 85 that is movably connected to the apparatus main body 1A. The fixing device 80 is connected to the apparatus main body 1A through the connection member 85.

The connection member 85 is rotatable about a rotation center 85A. When the tray unit 50 is pulled out to the outside of the apparatus main body 1A, the connection member 85 is moved outside the first space. The fixing device 80 is rotatably connected to one end of the connection member 85, and the other end of the connection member 85 is rotatably connected to the apparatus main body 1A about the rotation center 85A. The fixing device 80 is movable between the use position and the retracted position while being supported by the connection member 85 (i.e., while being connected to the apparatus main body 1A through the connection member 85). The connection member 85 is configured to be movable (swingable) with respect to the apparatus main body 1A and the fixing device 80. That is, the fixing device 80 is connected to the apparatus main body 1A through the connection member 85. As a result, compared to a configuration in which the fixing device 80 is directly connected to the apparatus main body 1A, the amount of movement of the fixing device 80 between the retracted position and the use position may be increased.

As illustrated in FIG. 7, when the tray unit 50 moves from the first inner position to the first outer position, the angle formed between the movement direction of the tray unit 50 and the horizontal direction H is smaller than that formed between the movement direction of the tray unit 50 and the vertical direction V. In addition, when the fixing device 80 moves from the use position to the retracted position, the amount of movement of the fixing device 80 in the vertical direction V is larger than that of movement of the fixing device 80 in the horizontal direction H. In other words, when the fixing device 80 moves from the use position to the retracted position, the amount of movement of the fixing device 80 in a direction perpendicular to the direction of movement of the tray unit 50 is greater than that of movement of the fixing device 80 in a direction parallel to the direction of movement of the tray unit 50.

In addition, the fixing device 80 may move between the use position and the retracted position while remaining attached to the apparatus main body 1A through a guide fixed to the apparatus main body 1A. In this case, the guide may have any shape.

However, the method for moving the fixing device 80 to the outside of the first space is not limited to this. For example, the fixing device 80 may be configured to be removable from the apparatus main body 1A so as to retract from the use position. In this manner, the fixing device 80 may move to the outside of the first space. That is, the fixing device 80 may be located outside the first space by being separated from the apparatus main body 1A and the door 20 (i.e., by being separated from the main frame 100). Furthermore, the fixing device 80 may be configured to be connected to the door 20. In this manner, the fixing device 80 may move to the outside of the first space by opening the door 20.

### Relationship between Tray Unit and Transfer Unit

With reference to FIGS. 1 to 7, the relationship between the tray unit 50 and the transfer unit 40 will be described.

When the fixing device 80 is in the position illustrated in FIG. 2, the tray handle 52 is hidden by the fixing device 80 and is therefore not grippable. When the fixing device 80 is located outside the first space as illustrated in FIG. 3, the user is able to grip the tray handle 52 of the tray unit 50 and move the tray unit 50 toward the outside of the apparatus main body 1A.

As illustrated in FIGS. 6 and 7, the position of the transfer unit 40 when an image forming operation is performed on the sheet S has the following relationship with the first space.

That is, when an image forming operation is performed on the sheet S, the transfer unit 40 is in the second inner position. As illustrated in FIGS. 6 and 7, at least a part of the transfer unit 40 in the second inner position overlaps with the first space. In other words, at least a part of the transfer unit 40 is located inside the first space, while the transfer unit 40 is in the second inner position.

In this embodiment, at least a part of the transfer unit 40 overlaps with the space through which the tray 51 passes when the tray unit 50 moves from the first inner position to the first outer position. However, it may alternatively be arranged so as to overlap with the space through which the cartridges P pass. As a result, compared to a configuration in which the transfer unit 40 in the second inner position is located outside the first space, the miniaturization of the apparatus main body 1A is achieved.

Note that in the printer 1 according to this embodiment, a part of the transfer unit 40 that overlaps with the first space is the cleaning portion 43 that accommodates the cleaning member 43A. However, another portion of the transfer unit 40 may also overlap with the first space. Furthermore, in this embodiment, the cleaning member 43A of the transfer unit 40, which is located in the second inner position, overlaps with the first space.

It can be said that the tray unit 50 and the transfer unit 40 satisfy the following relationship. While the tray unit 50 is in the first inner position and the transfer unit 40 is in the second inner position, a part (the cleaning portion 43) of the transfer unit 40 is located downstream of the tray unit 50 in the movement direction in which the tray unit 50 moves from the first inner position to the first outer position. In the vertical direction V, a region (range) in which a part (the cleaning portion 43) of the transfer unit 40 located downstream of the tray unit 50 is arranged at least partially overlaps with a region (range) in which the tray unit 50 is arranged.

Note that in this embodiment, when the door 20 is in the closed state, at least a part of the double-sided conveyance passage 20a overlaps with the second space through which the transfer unit 40 passes during movement from the second inner position to the second outer position. That is, when the door 20 is in the closed state, at least a part of the double-sided conveyance passage 20a is located inside the second space.

As described above, at least a part of the transfer unit 40 is located inside the first space, while the transfer unit 40 is in the second inner position. Therefore, in this embodiment, when the user moves the tray unit 50 from the first inner position to the first outer position with respect to the apparatus main body 1A, the transfer unit 40 is also moved from the second inner position to the second outer position with respect to the apparatus main body 1A. That is, in a state in which the transfer unit 40 and the tray unit 50 are integrated, the tray unit moves from the first inner position to the first outer position, and the transfer unit 40 moves from the second inner position to the second outer position.

By integrally moving the tray unit 50 and the transfer unit 40, exposure of the photosensitive drums 61 when the tray unit 50 moves to the first outer position is suppressed, making it possible to prevent the photosensitive drums 61 from being damaged or contaminated.

As illustrated in FIG. 7, when the door 20 is opened and the tray unit 50 is in the first outer position and the transfer unit 40 is in the second outer position, the transfer unit 40 supports the tray unit 50 from below the tray unit 50. In this embodiment, the door 20 also supports the transfer unit 40. That is, the transfer unit 40 supported by the door 20 supports the tray unit 50. It can also be said that the door 20 supports the tray unit 50 through the transfer unit 40 in this state.

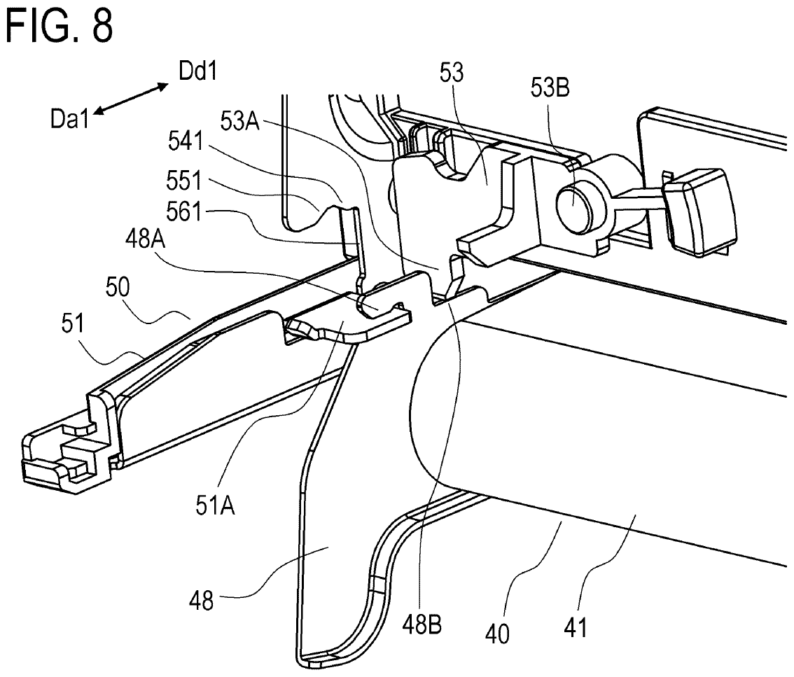

With reference to FIG. 8 to FIGS. 10A and 10B, the configuration for integrally moving the tray unit 50 and the transfer unit 40 will be described. FIG. 8 to FIGS. 10A and 10B are views illustrating a connection member (i.e., a lever, a stopper, or a lock member) 53 that connects the tray 51 of the tray unit 50 to the transfer unit 40.

The printer 1 according to this embodiment has the lock member 53. In this embodiment, the lock member 53 is provided on the tray 51 of the tray unit 50. The lock member 53 has a transfer lock portion 53A and is rotatable about a rotation center 53B.

The tray 51 has a transfer connection portion 51A. The transfer unit 40 includes the drive roller 46, the tension roller 47, and a transfer frame 48 that supports the primary transfer roller 42. The transfer frame 48 is provided with a tray connection groove 48A and a lock connection portion 48B.

When the lock member 53 rotates about the rotation center 53B, the transfer lock portion 53A engages with the lock connection portion 48B. Thus, the lock member 53 is movable to a connection position where the transfer unit 40 and the tray unit 50 are connected, and to a release position where they are retracted from the connection position.

When the transfer connection portion 51A engages with the tray connection groove 48A, the movement of the tray unit 50 with respect to the transfer unit 40 is restricted in a first removal direction Dd1 (pullout direction) and a direction orthogonal to the first removal direction Dd1. On the other hand, the movement of the transfer unit 40 with respect to the tray unit 50 is restricted in a second attachment direction Da2 and a direction orthogonal to the second attachment direction Da2.

A configuration similar to the above configuration is provided at four locations in total, i.e., near both ends of the tension roller 47 in the rotational axis direction and near both ends of the drive roller 46 in the rotational axis direction.

When the transfer lock portion 53A of the lock member 53 in the connection position engages with the lock connection portion 48B, the movement of the tray unit 50 with respect to the transfer unit 40 is restricted in a first attachment direction Da1 (insertion direction). On the other hand, the movement of the transfer unit 40 with respect to the tray unit 50 is restricted in a second removal direction Dd2.

The lock member 53 and the lock connection portion 48B may also be provided at both ends of the transfer unit 40 in the rotational axis direction of the tension roller 47.

That is, when the transfer connection portion 51A engages with the tray connection groove 48A and the lock member 53 in the connection position engages with the lock connection portion 48B, the relative movement between the transfer unit 40 and the tray unit 50 is restricted. Note that in this state, play may be present between the transfer unit 40 and the tray unit 50.

That is, it can be said that the transfer connection portion 51A and the lock member 53 function as tray-side connectors, while the tray connection groove 48A and the lock connection portion 48B function as transfer-side connectors. When the tray-side connectors and the transfer-side connectors are connected, the tray unit 50 and the transfer unit 40 are connected and integrally move.

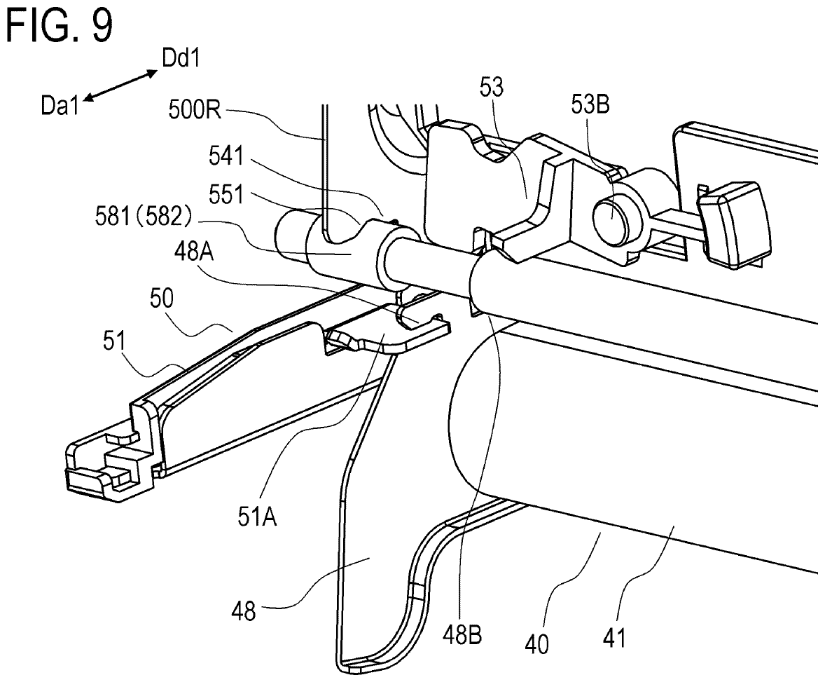

On the other hand, as illustrated in FIG. 9, the apparatus main body 1A has a connection shaft 581 with a circular cross section that is arranged so as to be orthogonal to the movement direction of the tray unit 50. When the tray unit 50 is in the first inner position and the transfer unit 40 is in the second inner position, the lock member 53 is in contact with the connection shaft 581 and is in the release position. In this state, the transfer lock portion 53A is separated from the lock connection portion 48B.

When the tray unit 50 is moved in the first removal direction Dd1 with the lock member 53 in the release position, the transfer unit 40 is pressed in the second removal direction Dd2 by the transfer connection portion 51A. As a result, the transfer unit 40 is also moved in the second removal direction Dd2 integrally with the tray unit 50. When the tray unit 50 moves in the first removal direction Dd1 by a specified distance, the lock member 53 separates from the connection shaft 581, moves to the connection position, and engages with the lock connection portion 48B. In a state in which the lock member 53 is in the connection position and engages with the lock connection portion 48B, the tray unit 50 is moved to the first outer position, and the transfer unit 40 is moved to the second outer position.

When the tray unit 50 is moved in the first attachment direction Da1 with the lock member 53 engaging with the lock connection portion 48B, the transfer unit 40 is pressed in the second attachment direction Da2 by the lock member 53. As a result, the transfer unit 40 is also moved integrally with the tray unit 50 in the second attachment direction Da2.

When the transfer unit 40 is moved in the second attachment direction Da2 with the lock member 53 engaging with the lock connection portion 48B, the transfer unit 40 presses the transfer connection portion 51A, and the tray unit 50 is pressed in the first attachment direction Da1. As a result, the tray unit 50 is also moved in the first attachment direction Da1 integrally with the transfer unit 40.

When the tray unit 50 and the transfer unit 40 are integrally moved toward the inside of the apparatus main body 1A, the lock member 53 is moved to the release position by the connection shaft 581. In this state, even if the tray unit 50 is moved in the first attachment direction Da1, the transfer unit 40 does not move. Therefore, during the process of closing the door 20, the transfer unit 40 is pressed in the second attachment direction Da2 by the contact force from the secondary transfer roller 45 pressing against the transfer unit 40 and pressed into the back (second inner position) of the apparatus main body 1A. That is, the door 20 may press the transfer unit 40 such that the transfer unit 40 is located in the second inner position. Furthermore, the door 20 may press the tray unit 50 such that the tray unit 50 is located in the first inner position.

On the other hand, when the transfer unit 40 is moved in the second removal direction Dd2 while the lock member 53 is in the release position and the tray unit 50 is in the first inner position, the transfer unit 40 may move from the second inner position to the second outer position independently of the tray unit 50. In the printer 1 according to this embodiment, as illustrated in FIG. 5, the transfer unit 40 may be moved to the outside (second outer position) of the apparatus main body 1A while the tray unit 50 remains located inside (first inner position) the apparatus main body 1A. The transfer unit 40 is removable from the apparatus main body 1A and replaceable with a new transfer unit 40.

In this embodiment, when the tray unit 50 is in the first inner position, it is positioned with respect to the apparatus main body 1A. Furthermore, when the transfer unit 40 is in the second inner position, no clearance is provided between the tray connection groove 48A and the transfer connection portion 51A so that the transfer unit 40 is accurately positioned with respect to the tray unit 50.

If it is desired to position the tray unit 50 and the transfer unit 40 independently of each other with respect to the apparatus main body 1A while the tray unit 50 is in the first inner position and the transfer unit 40 is in the second inner position, a clearance may be provided between the tray connection groove 48A and the transfer connection portion 51A.

### Movement of Tray Unit and Transfer Unit

As illustrated in FIGS. 1, 6, and 7, the tray unit 50 and the transfer unit 40 are inclined with respect to the horizontal direction H in a state in which they are attached to the apparatus main body 1A.

More specifically, when the tray unit 50 is in the first inner position, the rotational axis of a photosensitive drum 61 located closer to the first end 1b1 is positioned higher in the vertical direction V than the rotational axis of a photosensitive drum 61 located farther from the first end 1b1.

That is, when the tray unit 50 is in the first inner position, the second photosensitive drum is located closer to the first end 1b1 than to the first photosensitive drum, and the rotational axis of the second photosensitive drum is positioned higher in the vertical direction V than the rotational axis of the first photosensitive drum. Similarly, the third photosensitive drum is located closer to the first end 1b1 than to the second photosensitive drum, and the rotational axis of the third photosensitive drum is positioned higher in the vertical direction V than the rotational axis of the second photosensitive drum. The fourth photosensitive drum is located closer to the first end 1b1 than to the third photosensitive drum, and the rotational axis of the fourth photosensitive drum is positioned higher in the vertical direction V than the rotational axis of the third photosensitive drum.

Here, when viewed in the direction of the rotational axes of the photosensitive drums 61 as illustrated in FIG. 1 and the like, a straight line connecting the centers of the respective photosensitive drums 61 is defined as a straight line LD. In this embodiment, when the tray unit 50 is in the first inner position, the straight line LD is inclined upward with respect to the horizontal direction H from the side farther from the first end 1b1 toward the side closer to the first end 1b1. In addition, the contact surface of the belt 41 that is in contact with the first to fourth photosensitive drums is inclined upward from the side farther from the first end 1b1 toward the side closer to the first end 1b1.

When the tray unit 50 moves from the first inner position to the first outer position, it moves in a direction inclined with respect to the horizontal direction H (in this embodiment, a direction inclined upward with respect to the horizontal direction H). That is, when the tray unit 50 moves from the first inner position to the first outer position, it moves in an obliquely upward direction. When the tray unit 50 moves from the first inner position to the first outer position, the movement direction of the tray unit 50 changes from an obliquely upward direction to a downward direction. The movement direction of the tray unit 50 may also include a direction parallel to the horizontal direction H or an obliquely downward direction with respect to the horizontal direction H.

The angle formed between the straight line LD and the horizontal direction H is smaller when the tray unit 50 is in the first outer position than when it is in the first inner position. In this embodiment, when the tray unit 50 is in the first outer position, the straight line LD is parallel to the horizontal direction H. However, the straight line LD may also be inclined downward or upward with respect to the horizontal direction H.

Similarly, when the transfer unit 40 moves from the second inner position to the second outer position, the movement direction of the transfer unit 40 changes from an obliquely upward direction to a downward direction. The movement direction of the transfer unit 40 may also include a direction parallel to the horizontal direction H or an obliquely downward direction with respect to the horizontal direction H.

The angle formed between the contact surface of the belt 41 and the horizontal direction H is smaller when the transfer unit 40 is in the second outer position than when it is in the second inner position. In this embodiment, when the transfer unit 40 is in the second outer position, the contact surface of the belt 41 is parallel to the horizontal direction H. However, the contact surface may also be inclined downward or upward with respect to the horizontal direction H.

When the tray unit 50 is moved from the first outer position to the first inner position, it first moves in the horizontal direction H and then moves in an obliquely downward direction in the middle of the movement. When the transfer unit 40 is moved from the second outer position to the second inner position, it first moves in the horizontal direction H and then moves in an obliquely downward direction in the middle of the movement. According to this configuration, the own weights of the tray unit 50 and the transfer unit 40 may be utilized when inserting the tray unit 50 and the transfer unit 40 into the apparatus main body 1A.

### Positioning of Tray Unit

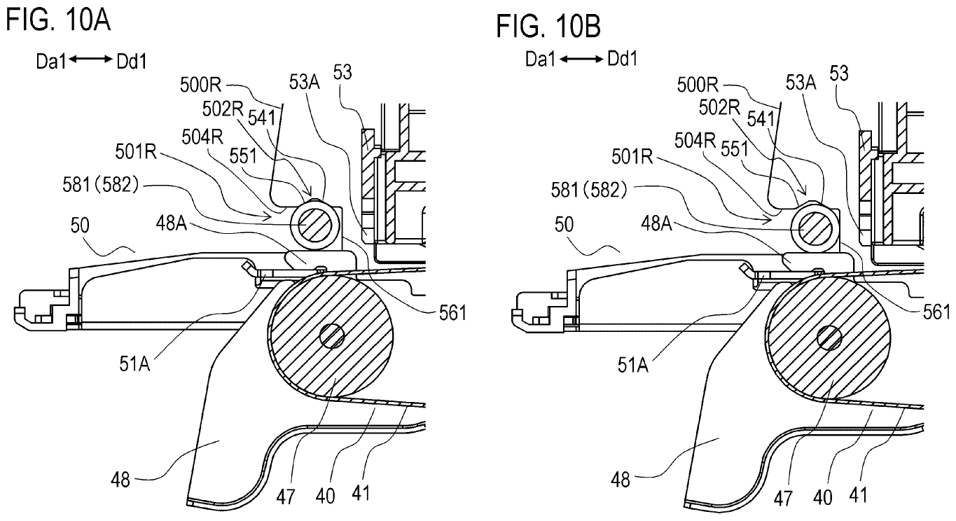

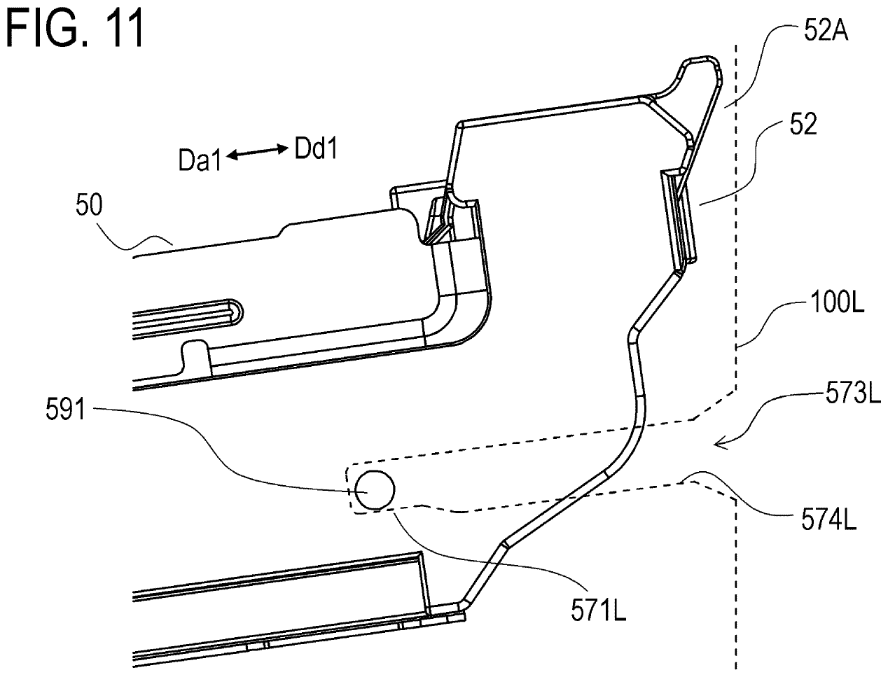

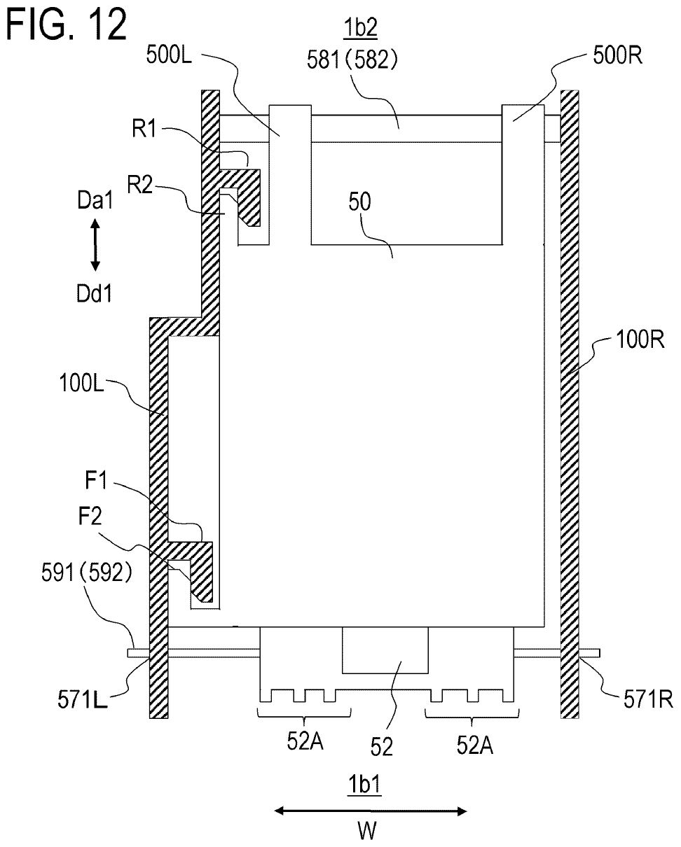

With reference to FIGS. 9 to 12, a method for positioning the tray unit 50 with respect to the apparatus main body 1A will be described. FIG. 9 is a cross-sectional view illustrating, among the positioning configurations of the tray unit 50 with respect to the apparatus main body 1A, the positioning configuration of the tray unit 50 on the front side (downstream side) in the insertion direction. FIG. 11 is a side view illustrating, among the positioning configurations of the tray unit 50 with respect to the apparatus main body 1A, the positioning configuration of the tray unit 50 on the rear side (upstream side) in the insertion direction. FIG. 12 is a schematic view illustrating the plan configuration of the left and right side frames of the apparatus main body 1A and the tray unit 50 when viewed in a direction orthogonal to both the insertion/removal direction of the tray unit 50 with respect to the apparatus main body 1A and the rotational axis direction of the photosensitive drums and the like. Note that FIG. 10 illustrates the respective configurations of the apparatus main body 1A and the tray unit 50 such that the insertion direction Da1 to the removal direction Dd1 is horizontal. In a state in which the printer 1 is installed on a horizontal plane, which is a typically assumed installation state, the insertion direction Da1 is a direction inclined downward from the upstream side to the downstream side.

As illustrated in FIG. 12, the frames constituting the apparatus main body 1A include a left side frame 100L and a right side frame 100R. The left side frame 100L has a first engagement portion F1 and a second engagement portion R1. The first engagement portion F1 and the second engagement portion R1 are hook-shaped engagement portions. The tray unit 50 has a first engaged portion F2 and a second engaged portion R2. The first engaged portion F2 and the second engaged portion R2 are hook-shaped engaged portions. When the tray unit 50 is inserted, the first engaged portion F2 and the second engaged portion R2 engage with the first engagement portion F1 and the second engagement portion R1, respectively, from the upstream side in the insertion direction Da1. As a result, the position of the tray unit 50 is restricted in a direction orthogonal to the movement direction of the tray unit 50. In other words, the engagement between the first engagement portion F1 and the first engaged portion F2, and between the second engagement portion R1 and the second engaged portion R2, restricts the relative movement between the apparatus main body 1A and the tray unit 50 in the width direction W, which intersects the insertion/removal direction.

As illustrated in FIG. 12, the connection shaft 581 is arranged on the second end 1b2 side of the apparatus main body 1A to connect the left side frame 100L and the right side frame 100R. The connection shaft 581 has a circular cross section, extends in a direction intersecting (orthogonal to in this embodiment) the movement direction of the tray unit 50, and is rotatably provided with respect to the left side frame 100L and the right side frame 100R. The connection shaft 581 is configured, as an engagement portion provided on the apparatus main body 1A, to be capable of engaging with engaged portions provided on the tray unit 50 when the tray unit 50 is attached to the apparatus main body 1A.

With reference to FIGS. 9, 10A, and 10B, the above-described engagement portion and the engaged portions will be described. Here, FIGS. 9, 10A, and 10B illustrate the configurations of the engagement portion and the engaged portions of the apparatus main body 1A and the tray unit 50 on the right side in the width direction W. On the left side opposite to the right side, the engagement portion and the engaged portions symmetrically configured in the width direction W are also provided. However, the engagement portion and the engaged portions may be provided on only one of the right side or the left side in the width direction.

As illustrated in FIGS. 9, 10A, and 10B, a first contact portion 541 and a second contact portion 551 that constitute a positioning portion 502R that positions the tray unit 50 with respect to the apparatus main body 1A are provided on the tip end side (i.e., the rear end side in the removal direction) of the tray unit 50 in the attachment direction. The first contact portion 541 and the second contact portion 551 are configured to be capable of contacting the connection shaft 581 of the apparatus main body 1A. The connection shaft 581 is arranged, with respect to the tray unit 50 in the attachment position, at a position closer to the tip end (downstream end) than to the rear end (upstream end) of the tray unit 50 in the attachment position. On the tip end side of the tray unit 50 in the attachment direction, a third contact portion 561 is further is provided to define the movement limit position of the tray unit 50 in the attachment direction with respect to the apparatus main body 1A. The third contact portion 561 is also configured to be capable of contacting the connection shaft 581 of the apparatus main body 1A. The first contact portion 541 and the second contact portion 551 of the positioning portion 502R and the third contact portion 561 constitute the engaged portions of the tray unit 50 with which the connection shaft 581 of the apparatus main body 1A, which serves as the engagement portion, is capable of engaging.

The tray unit 50 has a tray right frame 500R that faces a right side frame 100R of the apparatus main body 1A, and the tray right frame 500R is provided with a guide groove 501R recessed in a direction opposite to the attachment direction (pullout direction). When the tray unit 50 is inserted into the apparatus main body 1A up to the attachment position, the connection shaft 581 of the apparatus main body 1A is inserted into the guide groove 501R along the insertion/removal direction. The positioning portion 502R, which includes the first contact portion 541 and the second contact portion 551, and the third contact portion 561 form a part of a groove forming portion that forms the guide groove 501R.

When the tray unit 50 is attached to the apparatus main body 1A, an upper surface 504R that is a surface region of the guide groove 501R that faces substantially downward rests on the connection shaft 581, whereby the connection shaft 581 supports the tip end side of the tray unit 50 in the insertion direction. The positioning portion 502 including the first contact portion 541 and the second contact portion 551 is provided as a downwardly recessed portion on the upper surface 504R of the guide groove 501R that is recessed in the upward direction. During the attachment of the tray unit 50 to the apparatus main body 1A, the upper surface 504R moves so as to slide over the connection shaft 581, and the connection shaft 581 is fitted into the positioning portion 502 that is a downwardly recessed portion. In this embodiment, the connection shaft 581 is rotatably provided in the apparatus main body 1A. Therefore, the relative movement between the connection shaft 581 and the guide groove 501R becomes smooth when the tray unit 50 is inserted.

The first contact portion 541 is configured to restrict the movement of the tray unit 50 in the attachment direction (insertion direction) toward the apparatus main body 1A by contacting the connection shaft 581. When the tray unit 50 is in a posture attached to the apparatus main body 1A, the first contact portion 541 is configured as a first inclined surface that is inclined with respect to the insertion/removal direction of the tray unit 50 relative to the apparatus main body 1A. The direction in which the first contact portion 541, which serves as the first inclined surface, extends is a direction that intersects both the horizontal direction and the gravity direction. The direction (normal direction) in which the first contact portion 541, which serves as the first inclined surface, faces is a direction that includes a component in the insertion direction (Da1) of the tray unit 50 with respect to the apparatus main body 1A.

The second contact portion 551 is configured to restrict the movement of the tray unit 50 in a direction opposite to the attachment direction (i.e., the movement of the tray unit 50 in the pullout direction) of the tray unit 50 with respect to the apparatus main body 1A by contacting the connection shaft 581. When the tray unit 50 is in a posture attached to the apparatus main body 1A, the second contact portion 551 is configured as a second inclined surface that is inclined with respect to the insertion/removal direction of the tray unit 50 relative to the apparatus main body 1A. The direction in which the second contact portion 551, which serves as the second inclined surface, extends is a direction that intersects both the horizontal direction and the gravity direction. The direction (normal direction) in which the second contact portion 551, which serves as the second inclined surface, faces is a direction that includes a component in the pullout direction (Dd1) of the tray unit 50 with respect to the apparatus main body 1A.

When both the first contact portion 541 and the second contact portion 551 of the tray unit 50 are simultaneously in contact with the connection shaft 581 of the apparatus main body 1A, the tray unit 50 is positioned in the horizontal direction H with respect to the apparatus main body 1A. When both the first contact portion 541 and the second contact portion 551 of the tray unit 50 are simultaneously in contact with the connection shaft 581 of the apparatus main body 1A, the tray unit 50 is positioned in the vertical direction V with respect to the apparatus main body 1A. When both the first contact portion 541 and the second contact portion 551 of the tray unit 50 are simultaneously in contact with the connection shaft 581 of the apparatus main body 1A, the tray unit 50 is positioned with respect to the apparatus main body 1A in the insertion direction Da1, the pullout direction Dd1, and a direction orthogonal to these directions. When both the first contact portion 541 and the second contact portion 551 of the tray unit 50 are simultaneously in contact with the connection shaft 581 of the apparatus main body 1A, the tray unit 50 is in the positioning position (attachment position).

The third contact portion 561 is provided at the innermost part of the guide groove 501R that is located upstream of the first contact portion 541 and the second contact portion 551 in the insertion direction of the tray unit 50. The third contact portion 561 is provided at a position where it does not contact the connection shaft 581, in a state in which both the first contact portion 541 and the second contact portion 551 are in contact with the connection shaft 581 (i.e., a state in which they are positioned by the positioning portion 502R). The guide groove 501R is configured such that its width in a direction intersecting the insertion/removal direction (i.e., the attachment direction and the pullout direction) of the tray unit 50 has a specified play with respect to the width of the cross section of the connection shaft 581 in the same direction. Therefore, for example, when the tray unit 50 is inserted with an excessive force, the tray unit 50 can be inserted such that the connection shaft 581 may be inserted into the back side of the guide groove 501R beyond the positioning position (i.e., the attachment position) defined by the positioning portion 502R. When the connection shaft 581 is inserted into the back side of the guide groove 501R beyond the positioning position defined by the positioning portion 502R as described above and then reaches a restricted position, the third contact portion 561 contacts the connection shaft 581 to restrict the insertion of the tray unit 50. That is, when the third contact portion 561 contacts the connection shaft 581, the movement limit position of the tray unit 50 in the attachment direction with respect to the apparatus main body 1A is defined. If an external force for pressing the tray unit 50 in the attachment direction is no longer applied when the tray unit 50 is in the restricted position where the third contact portion 561 contacts the connection shaft 581, the state in which the third contact portion 561 is in contact with the connection shaft 581 is not maintained. Specifically, the tray unit 50 is configured to return, under its own weight, to a position where it is positioned by the positioning portion 502R. In this embodiment, an inclined surface that is inclined downward from the third contact portion 561 to the first contact portion 541 of the positioning portion 502R is continuously provided as a return portion. When the inclined surface slides over the connection shaft 581, the connection shaft 581 is accommodated in the positioning portion 502R (i.e., it comes into contact with both the first contact portion 541 and the second contact portion 551), that is, the tray unit 50 automatically returns to the positioning position.

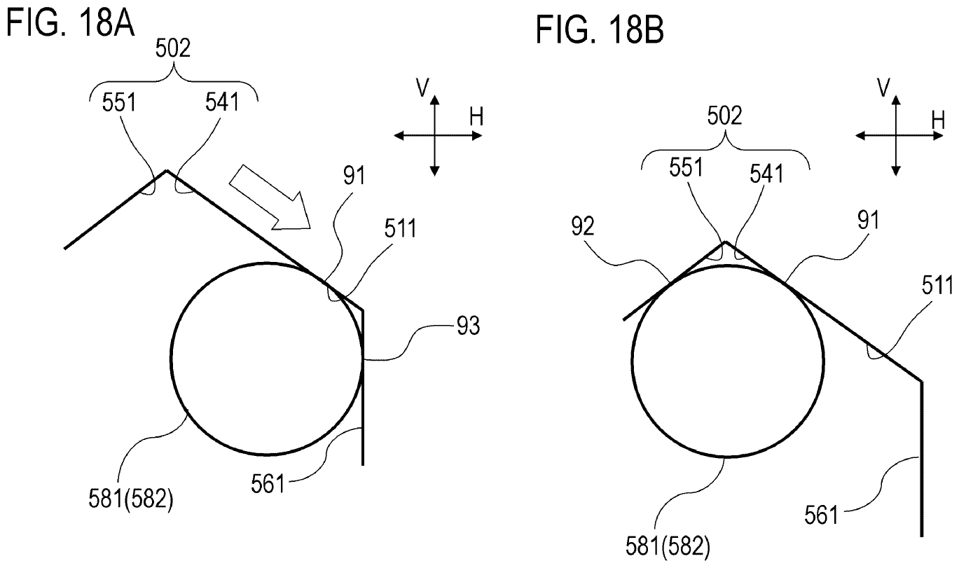

FIGS. 18A and 18B are schematic views illustrating, in a simplified manner, the configurations of the engagement portion and the engaged portions in this embodiment. FIG. 18A illustrates a state in which the third contact portion 561 that is provided on the tray unit 50 and serves as a restriction portion is in contact with the connection shaft 581 that is provided on the apparatus main body 1A and serves as the engagement portion, and in which the tray unit 50 is in the restricted position. FIG. 18B illustrates a state in which the first contact portion 541 and the second contact portion 551 that are provided on the tray unit 50 and constitute the engaged portions are in contact with the connection shaft 581 that is provided on the apparatus main body 1A and serves as the engagement portion, and in which the tray unit 50 is in the attachment position (positioning position). As illustrated in FIGS. 18A and 18B, the connection shaft 582 has a first contacted portion 91 that contacts the first contact portion 541, a second contacted portion 92 that contacts the second contact portion 551, and a third contacted portion 93 that contacts the third contact portion 561.

As illustrated in FIG. 18A, when the tray unit 50 is inserted further downstream in the insertion direction beyond the attachment position (positioning position), the third contact portion 561 of the tray unit 50 contacts the connection shaft 581 of the apparatus main body 1A to restrict the movement of the tray unit 50 in the insertion direction. At this time, the connection shaft 581 is separated from at least the second contact portion 551. In this embodiment, the connection shaft 581 is separated from both the first contact portion 541 and the second contact portion 551. At this time, the inclined surface 511 of the tray unit 50 contacts, in the gravity direction, the connection shaft 581 that supports the tip end side of the tray unit 50 in the insertion direction. The inclined surface 511 is an inclined surface that extends in a direction intersecting both the horizontal direction and the gravity direction, in a state in which the connection shaft 581 is in contact with the inclined surface 511. Therefore, when an external force (excluding gravity) acting on the tray unit 50 is no longer applied, the state in which the third contact portion 561 is in contact with the connection shaft 581 is not maintained, and the inclined surface 511 slides over the connection shaft 581 under its own weight, whereby the tray unit 50 returns to the attachment position (positioning position). As a result, as illustrated in FIG. 18B, a state in which both the first contact portion 541 and the second contact portion 551 are in contact with the connection shaft 581 is established. That is, the inclined surface 511 functions as a return portion.

In the configuration example illustrated in FIGS. 18A and 18B, the inclined surface 511 serving as the return portion is formed as an inclined surface that is continuous with the first contact portion 541, and the first contact portion 541 and the inclined surface 511 form a straight line. However, the relationship between the first contact portion 541 and the inclined surface 511 is not limited to the above relationship. For example, the inclined surface 511 may be configured as an inclined surface that is separated from (discontinuous with) the first contact portion 541, may have an inclination angle different from that of the first contact portion 541, or may be a surface that bends or curves at its intermediate portion. That is, various configurations may be adopted, as long as the tray unit 50 is capable of functioning as the return portion that moves from the restricted position to the attachment position under its own weight.

As illustrated in FIG. 12, the tray unit 50 also has a tray left frame 500L that faces the left side frame 100L of the apparatus main body 1A. Although not illustrated, the tray left frame 500L is provided with engaged portions having the same configurations as those of the engaged portions that include the positioning portion 502R (the first contact portion 541 and the second contact portion 551) and the third contact portion 561 that are provided on the tray right frame 500R.

As illustrated in FIGS. 11 and 12, a tray shaft 591 that extends outside the left side frame 100L and the right side frame 100R of the apparatus main body 1A is provided on the side of the tray unit 50 that is close to the tray handle 52 serving as a grip portion. The tray shaft 591 is arranged, with respect to the tray unit 50 in the attachment position, at a position closer to the rear end (upstream end) than the tip end (downstream end) of the tray unit 50 in the attachment direction (insertion direction) of the tray unit 50. Fourth contact portions 571L and 571R are provided on the left side frame 100L and the right side frame 100R of the apparatus main body 1A, respectively. The fourth contact portions 571L and 571R are parts of guide grooves that are provided on the left side frame 100L and the right side frame 100R, respectively, and guide the tray shaft 591 in the insertion/removal direction of the tray unit 50.

FIG. 11 illustrates a guide groove 573L of the left side frame 100L. The guide groove 573L is formed in a groove shape extending in the insertion/removal direction of the tray unit 50, and has a lower surface 574L that is a surface region facing substantially upward. When the tray unit 50 is attached to the apparatus main body 1A, the tray shaft 591 rests on the lower surface 574L, whereby the guide groove 573L (the lower surface 574L) supports the rear end side of the tray unit 50 in the insertion direction. The fourth contact portion 571L is formed as a part of the lower surface 574L in the guide groove 573L. A guide groove 573R having the same configuration is also provided on the right side frame 100R. The tray shaft 591 of the tray unit 50 abuts against the fourth contact portions 571L and 571R of the left side frame 100L and the right side frame 100R, respectively. As a result, the movement of the tray unit 50 with respect to the guide groove 573L of the tray shaft 591 is restricted in a direction intersecting the insertion direction of the tray unit 50. Accordingly, the tray unit 50 is positioned in the vertical direction V (gravity direction) with respect to the apparatus main body 1A. The tray shaft 591 has a circular cross section and is a single shaft member that penetrates the tray unit 50.

The tray unit 50 is configured such that when the positioning portion on the tip end side in the attachment direction is positioned by the connection shaft 581 of the apparatus main body 1A, the tray shaft 591 is brought into contact with the fourth contact portions 571L and 571R and positioned on the rear end side in the attachment direction. The length (depth) of the guide groove 573L in the insertion/removal direction of the tray unit 50 is such that the tray shaft 591 does not contact the innermost end of the guide groove 573L even when the tray unit 50 is inserted up to the position where the third contact portion 561 contacts the connection shaft 581 on the tip end side in the attachment direction.

According to the above configuration, the tray unit 50 is positioned with respect to the apparatus main body 1A.

Here, in a state in which both the first contact portion 541 and the second contact portion 551 are in the positioning position where they are in contact with the connection shaft 581, the tray unit 50 is in the specified attachment position with respect to the apparatus main body 1A, and the printer 1 is capable of performing an image forming operation. The third contact portion 561 is not directly involved in the positioning of the tray unit 50 during an image forming operation. Therefore, even if deformation (wear) occurs due to the repeated pulling-out and attachment of the tray unit 50 or the attachment of the tray unit 50 with an excessive force, the influence on the positioning accuracy of the tray unit 50 may be suppressed.

In this embodiment, the connection shaft 581 is formed as a single shaft member having a circular cross section that connects the left side frame 100L and the right side frame 100R. However, the same effect may be obtained even if the shaft does not have a circular cross section.

In this embodiment, the first contact portion 541 and the second contact portion 551 that constitute the positioning portion 502 are formed as linear inclined surfaces. The angle formed between the first contact portion 541 and the second contact portion 551 may be arbitrarily set depending on the angle of the tray unit 50 relative to the apparatus main body 1A or the own weight of the tray unit 50. The configuration of the positioning portion 502 is not limited to the configuration of this embodiment. For example, the same effect as in this embodiment may be obtained even if the first contact portion 541 and the second contact portion 551 are formed as curved surfaces.

In this embodiment, the third contact portion 561 of the tray unit 50 abuts against the connection shaft 581 of the apparatus main body 1A to restrict the excessive insertion of the tray unit 50. However, the configuration is not limited to this. For example, instead of providing the third contact portion 561 of the tray unit 50, a third contact portion may be provided on the apparatus main body 1A. The third contact portion may contact parts other than the connection shaft 581, as long as the function of restricting the excessive insertion of the tray unit 50 is secured and the return portion functions properly.

### Second Embodiment

With reference to FIGS. 12 to 15, a method for positioning the tray unit 50 with respect to the apparatus main body 1A in the image forming apparatus according to a second embodiment of the present disclosure will be described. In this embodiment, components common to those of the first embodiment are denoted by the same reference numerals, and components that differ from those in the first embodiment will be mainly described. Matters not specifically described in this embodiment are the same as those in the first embodiment.

In the first embodiment, the positioning configuration of the tray unit 50 in the insertion/removal direction, which includes the engagement portion and the engaged portions, is arranged on the front side of the tray unit 50 in the insertion direction, while the positioning configuration of the tray unit 50 in the vertical direction V (gravity direction) is arranged on the rear side of the tray unit 50 in the insertion direction. On the other hand, in the second embodiment, the positioning configuration of the tray unit 50 in the insertion/removal direction, which includes the engagement portion and the engaged portions, is arranged on the rear side of the tray unit 50 in the insertion direction, while the positioning configuration of the tray unit 50 in the vertical direction V (gravity direction) is arranged on the front side of the tray unit 50 in the insertion direction.

Furthermore, in the first embodiment, the engagement portion is provided on the apparatus main body 1A, while the engaged portions are provided on the tray unit 50. On the other hand, in the second embodiment, the engagement portion is provided on the tray unit 50, while the engaged portions are provided on the apparatus main body 1A.

As illustrated in FIG. 12, the apparatus main body 1A includes the left side frame 100L and the right side frame 100R. The left side frame 100L includes the first engagement portion F1 and the second engagement portion R1 that are capable of restricting the positions of the tray unit 50 that are orthogonal to its movement direction.

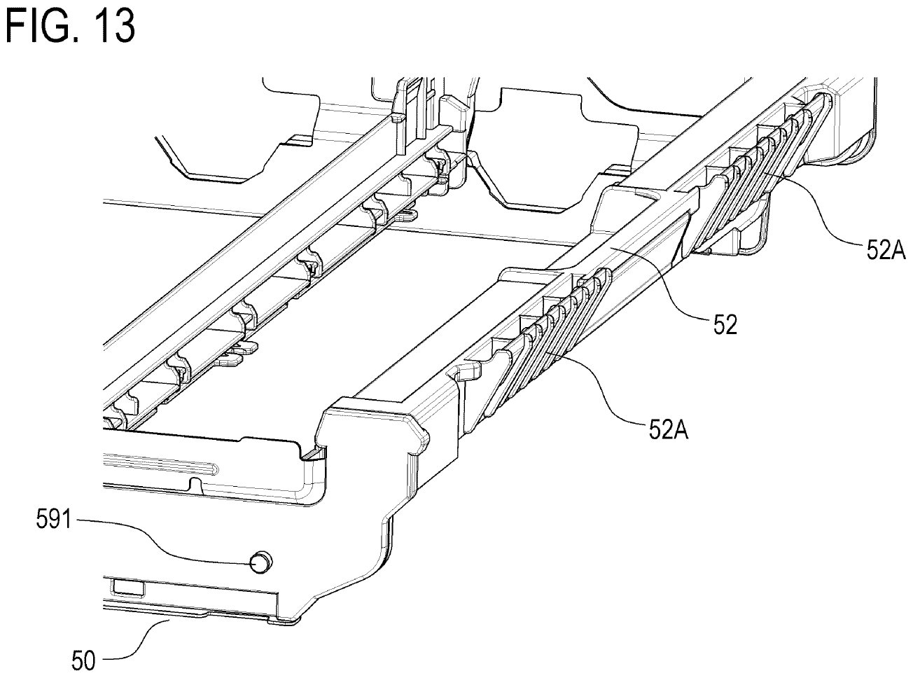

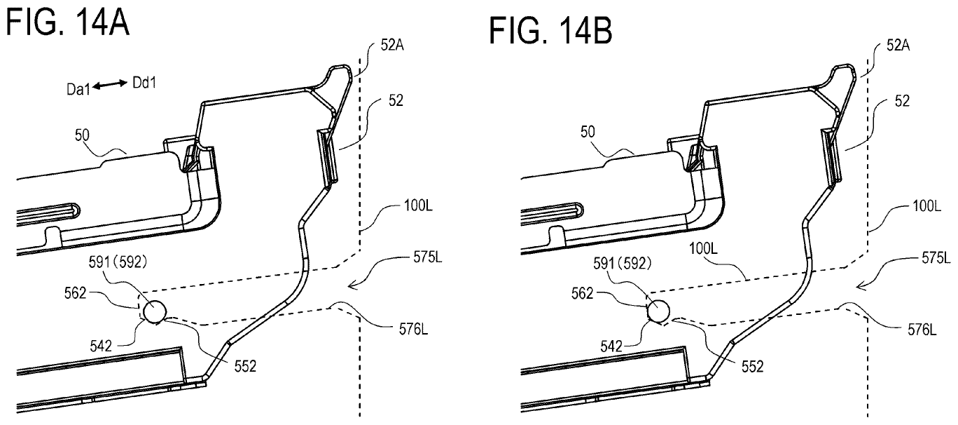

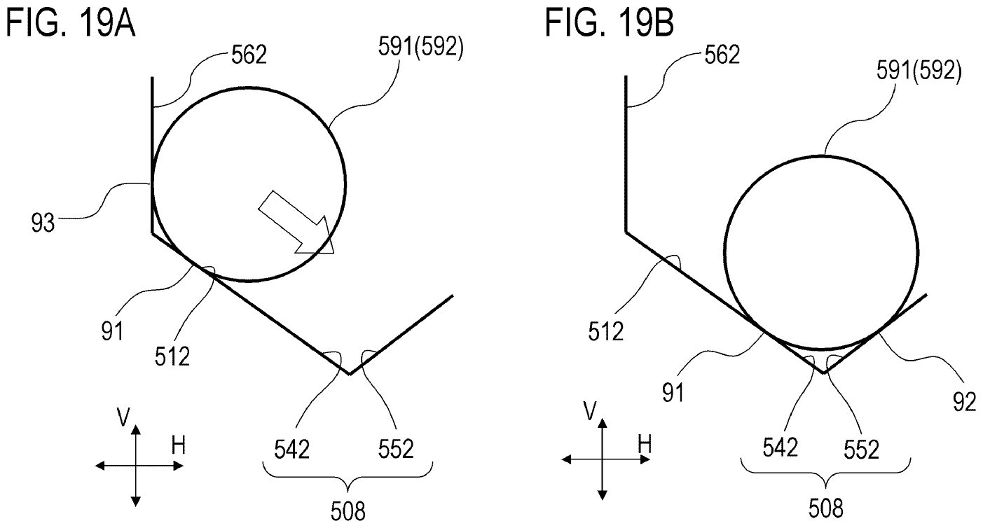

As illustrated in FIGS. 13 and 14, the tray shaft 591 that extends outside the left side frame 100L and the right side frame 100R is provided on the side of the tray unit 50 that is close to the tray handle 52. The tray shaft 591 is configured to have a circular cross section and is a single shaft member that penetrates the tray unit 50. The tray shaft 591 constitutes the engagement portion provided on the tray unit 50. The left side frame 100L and the right side frame 100R are, respectively, provided with a first contact portion 542 that restricts the movement of the tray unit 50 in the attachment direction and a second contact portion 552 that restricts the movement of the tray unit 50 in the direction opposite to the attachment direction. The first contact portion 542 and the second contact portion 552 constitute a positioning portion 508 (see FIG. 19) that positions the tray unit 50 with respect to the apparatus main body 1A. In addition, the left side frame 100L and the right side frame 100R are provided with a third contact portion 562 that defines the movement limit position of the tray unit 50 in the attachment direction with respect to the apparatus main body 1A. The first contact portion 542 and the second contact portion 552 that constitute the positioning portion 508 and the third contact portion 562 constitute the engaged portions of the apparatus main body 1A with which the tray shaft 591 of the tray unit 50 serving as the engagement portion is capable of engaging.

FIG. 14 illustrates a guide groove 575L of the left side frame 100L. The guide groove 575L is formed in a groove shape extending in the insertion/removal direction of the tray unit 50, and has a lower surface 576L that is a region facing substantially upward. When the tray unit 50 is attached to the apparatus main body 1A, the tray shaft 591 rests on the lower surface 576L, whereby the guide groove 575L supports the rear end side of the tray unit 50 in the insertion direction (lower surface 576L). The positioning portion 508 including the first contact portion 542 and the second contact portion 552 is provided on the lower surface 576L of the guide groove 575L as an upwardly recessed portion that is recessed downward. During the attachment of the tray unit 50 to the apparatus main body 1A, the tray shaft 591 moves so as to slide over the lower surface 576R, and the tray shaft 591 is fitted into the positioning portion 502 that is a recessed portion. In this embodiment, the tray shaft 591 is rotatably provided in the tray unit 50. Therefore, the relative movement between the tray shaft 591 and the guide groove 575L becomes smooth when the tray unit 50 is inserted.

The first contact portion 542 is configured to restrict the movement of the tray unit 50 in the attachment direction (insertion direction) toward the apparatus main body 1A by contacting the tray shaft 591. The first contact portion 542 is configured as a first inclined surface that is inclined with respect to the insertion/removal direction of the tray unit 50 relative to the apparatus main body 1A. The direction in which the first contact portion 542, which serves as the first inclined surface, extends is a direction that intersects both the horizontal direction and the gravity direction. The direction (normal direction) in which the first contact portion 542, which serves as the first inclined surface, faces is a direction that includes a component in the pullout direction (Dd1) of the tray unit 50 with respect to the apparatus main body 1A.

The second contact portion 552 is configured to restrict the movement of the tray unit 50 in the direction opposite to the attachment direction (i.e., the movement of the tray unit 50 in the pullout direction) of the tray unit 50 with respect to the apparatus main body 1A by contacting the tray shaft 591. The second contact portion 552 is configured as a second inclined surface that is inclined with respect to the insertion/removal direction of the tray unit 50 relative to the apparatus main body 1A. The direction in which the second contact portion 552, which serves as the second inclined surface, extends is a direction that intersects both the horizontal direction and the gravity direction. The direction (normal direction) in which the second contact portion 552, which serves as the second inclined surface, faces is a direction that includes a component in the insertion direction (Da1) of the tray unit 50 with respect to the apparatus main body 1A.

When the tray shaft 591 of the tray unit 50 is simultaneously in contact with both the first contact portion 542 and the second contact portion 552 of the apparatus main body 1A, the tray unit 50 is positioned in the horizontal direction H with respect to the apparatus main body 1A. When the tray shaft 591 of the tray unit 50 is simultaneously in contact with both the first contact portion 542 and the second contact portion 552 of the apparatus main body 1A, the tray unit 50 is positioned in the vertical direction V with respect to the apparatus main body 1A. When the tray shaft 591 of the tray unit 50 is simultaneously in contact with both the first contact portion 542 and the second contact portion 552 of the apparatus main body 1A, the tray unit 50 is positioned with respect to the apparatus main body 1A in the insertion direction Da1, the pullout direction Dd1, and a direction orthogonal to these directions. When the tray shaft 591 of the tray unit 50 is simultaneously in contact with both the first contact portion 542 and the second contact portion 552 of the apparatus main body 1A, the tray unit 50 is in the positioning position (attachment position).

The third contact portion 562 is provided at the innermost part of the guide groove 575L that is located downstream of the first contact portion 542 and the second contact portion 552 in the insertion direction of the tray unit 50. The third contact portion 562 is provided at a position where it does not contact the tray shaft 591, in a state in which the tray shaft 591 is in contact with both the first contact portion 542 and the second contact portion 552 (i.e., a state in which it is positioned by the positioning portion 508). The guide groove 575L is configured such that its width in a direction intersecting the insertion/removal direction (i.e., the attachment direction and the pullout direction) of the tray unit 50 has a specified play with respect to the width of the cross section of the tray shaft 591 in the same direction. Therefore, for example, when the tray unit 50 is inserted with an excessive force, the tray unit 50 may be inserted such that the tray shaft 591 is inserted into the back side of the guide groove 575L beyond the positioning position (i.e., the attachment position) defined by the positioning portion 508. When the tray shaft 591 is inserted into the back side of the guide groove 575L beyond the positioning position defined by the positioning portion 508 as described above and then reaches a restricted position, the tray shaft 591 contacts the third contact portion 562 to restrict the insertion of the tray unit 50. That is, when the third contact portion 562 contacts the tray shaft 591, the movement limit position of the tray unit 50 in the attachment direction with respect to the apparatus main body 1A is defined.

If an external force for pressing the tray unit 50 in the attachment direction is no longer applied when the tray unit 50 is in the restricted position where the tray shaft 591 contacts the third contact portion 562, the state in which the tray shaft 591 is in contact with the third contact portion 562 is not maintained. Specifically, the tray unit 50 is configured to return, under its own weight, to a position where it is positioned by the positioning portion 508. In this embodiment, an inclined surface that is inclined downward from the third contact portion 562 to the first contact portion 542 of the positioning portion 508 is continuously provided as a return portion. When the tray shaft 591 slides over the inclined surface, the tray shaft 591 is accommodated in the positioning portion 508 (i.e., it comes into contact with both the first contact portion 542 and the second contact portion 552), that is, the tray unit 50 automatically returns to the positioning position.

FIGS. 19A and 19B are schematic views illustrating, in a simplified manner, the configurations of the engagement portion and the engaged portions in this embodiment. FIG. 19A illustrates a state in which the tray shaft 591 that is provided on the tray unit 50 and serves as the engagement portion is in contact with the third contact portion 562 that is provided on the apparatus main body 1A and serves as the restriction portion, and in which the tray unit 50 is in the restricted position. FIG. 19B illustrates a state in which the tray shaft 591 that is provided on the apparatus main body 1A and serves as the engagement portion is in contact with the first contact portion 542 and the second contact portion 552 that are provided on the tray unit 50 and constitute the engaged portions, and in which the tray unit 50 is in the attachment position (positioning position). As illustrated in FIGS. 19A and 19B, the tray shaft 591 has the first contacted portion 91 that contacts the first contact portion 542, the second contacted portion 92 that contacts the second contact portion 552, and a third contacted portion 93 that contacts the third contact portion 562.

As illustrated in FIG. 19A, when the tray unit 50 is inserted further downstream in the insertion direction beyond the attachment position (positioning position), the tray shaft 591 of the tray unit 50 contacts the third contact portion 562 of the apparatus main body 1A to restrict the movement of the tray unit 50 in the insertion direction. At this time, the tray shaft 591 is separated from at least the second contact portion 552. In this embodiment, the connection shaft 581 is separated from both the first contact portion 542 and the second contact portion 552. At this time, the tray shaft 591 contacts, in the gravity direction, an inclined surface 512 of the guide groove 575L of the apparatus main body 1A that supports the rear end side of the tray unit 50 in the insertion direction. The inclined surface 512 is an inclined surface that extends in a direction intersecting both the horizontal direction and the gravity direction, in a state in which the tray shaft 591 is in contact with the inclined surface 512. Therefore, when an external force (excluding gravity) acting on the tray unit 50 is no longer applied, the state in which the tray shaft 591 is in contact with the third contact portion 562 is not maintained, and the tray shaft 591 slides over the inclined surface 512 under its own weight, whereby the tray unit 50 returns to the attachment position (positioning position). That is, as illustrated in FIG. 19B, a state in which the tray shaft 591 is in contact with both the first contact portion 542 and the second contact portion 552 is established. That is, the inclined surface 512 functions as a return portion.

In the configuration example illustrated in FIGS. 19A and 19B, the inclined surface 512 serving as the return portion is formed as an inclined surface that is continuous with the first contact portion 542, and the first contact portion 542 and the inclined surface 512 form a straight line. However, the relationship between the first contact portion 542 and the inclined surface 512 is not limited to the above relationship. For example, the inclined surface 512 may be configured as an inclined surface that is separated from (discontinuous with) the first contact portion 542, may have an inclination angle different from that of the first contact portion 542, or may be a surface that bends or curves at its intermediate portion. That is, various configurations may be adopted, as long as the tray unit 50 is capable of functioning as the return portion that moves from the restricted position to the attachment position under its own weight.

Although not illustrated, the tray right frame 500R is also provided with engaged portions having the same configurations as those of the engaged portions that include the positioning portion 508 (the first contact portion 542 and the second contact portion 552) and the third contact portion 562 that are provided on the tray left frame 500L.

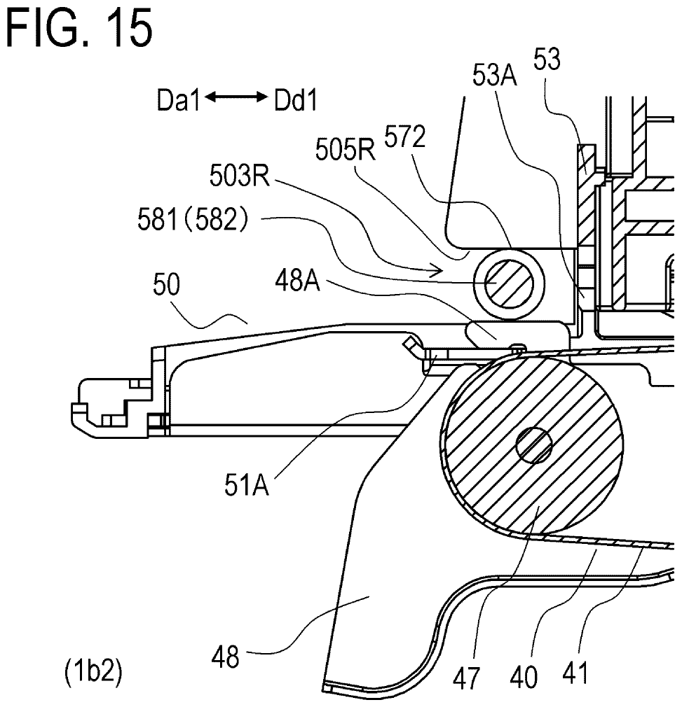

As illustrated in FIGS. 12 and 15, the connection shaft 581 is provided on the second end 1b2 side of the apparatus main body 1A to connect the left side frame 100L and the right side frame 100R. The tray unit 50 is provided with a fourth contact portion 572. Because the fourth contact portion 572 of the tray unit 50 abuts against the connection shaft 581 of the apparatus main body 1A, the movement of the tray unit 50 with respect to the connection shaft 581 of the guide groove 503R is restricted in a direction intersecting the insertion direction of the tray unit 50. Accordingly, the tray unit 50 is positioned in the vertical direction V. The connection shaft 581 has a circular cross section and extends in a direction orthogonal to the movement direction of the tray unit 50.

The tray unit 50 has the tray right frame 500R that faces the right side frame 100R of the apparatus main body 1A, and the tray right frame 500R is provided with the guide groove 503R recessed in a direction opposite to the attachment direction (pullout direction). When the tray unit 50 is inserted into the apparatus main body 1A up to the attachment position, the connection shaft 581 of the apparatus main body 1A is inserted into the guide groove 503R along the insertion/removal direction. The guide groove 503R has an upper surface 505R that is a surface region facing substantially downward. When the tray unit 50 is attached to the apparatus main body 1A, the upper surface 505R rests on the connection shaft 581, whereby the connection shaft 581 supports the tip end side of the tray unit 50 in the insertion direction.

The fourth contact portion 572 is formed as a part of the upper surface 505R in the guide groove 503R. A guide groove having the same configuration as that of the guide groove 503R of the tray right frame 500R is also provided on the tray left frame 500L. When the respective fourth contact portions 572 of the left side frame 100L and the right side frame 100R abut against the connection shaft 581 of the apparatus main body 1A, the tray unit 50 is positioned in the vertical direction V (gravity direction) with respect to the apparatus main body 1A.

The tray unit 50 is configured such that when the tray shaft 591 on the rear end side in the attachment direction is positioned by the positioning portion of the apparatus main body 1A, the fourth contact portion 572 is brought into contact with the connection shaft 581 and positioned on the tip end side in the attachment direction. The length (depth) of the guide groove 503R in the insertion/removal direction of the tray unit 50 is such that the connection shaft 581 does not contact the innermost end of the guide groove 503R even when the tray unit 50 is inserted up to the position where the tray shaft 591 contacts the third contact portion 562 on the rear end side in the attachment direction.

According to the above configuration, the tray unit 50 is positioned with respect to the apparatus main body 1A.

Here, in a state in which both the first contact portion 542 and the second contact portion 552 are in the positioning position where they are in contact with the tray shaft 591, the tray unit 50 is in the specified attachment position with respect to the apparatus main body 1A, and the printer 1 is capable of performing an image forming operation. The third contact portion 562 is not directly involved in the positioning of the tray unit 50 during an image forming operation. Therefore, even if wear occurs due to the repeated pulling-out and attachment of the tray unit 50 or the attachment of the tray unit 50 with an excessive force, the influence on the positioning accuracy of the tray unit 50 may be suppressed.

On both sides of the tray handle 52, sheet conveyance portions 52A extending from the drive roller 46 of the transfer unit 40 to the fixing device 80 are provided. Furthermore, the drive roller 46 and the fixing device 80 are positioned by the left side frame 100L and the right side frame 100R like the tray shaft 591. Because the tray shaft 591, the transfer unit 40, and the fixing device 80 are close to each other as illustrated in FIG. 1, their positions may be ensured with high accuracy.

As a result, the distance between the cartridge PY and the fixing device 80 is more easily ensured, thereby facilitating the management of thermal influence from the fixing device 80 and allowing for stable sheet conveyance.

In this embodiment, the tray shaft 591 is formed as a single shaft member having a circular cross section that penetrates the tray unit 50. However, the same effect may be obtained even if the shaft does not have a circular cross section.

In this embodiment, the first contact portion 542 and the second contact portion 552 that constitute the positioning portion 508 are formed as linear inclined surfaces, and the overall shape of the positioning portion 508 is a substantially V-shape. The angle of the V-shape formed between the first contact portion 542 and the second contact portion 552 may be arbitrarily set depending on the angle of the tray unit 50 relative to the apparatus main body 1A or the own weight of the tray unit 50. The configuration of the positioning portion 508 is not limited to the configuration of this embodiment. For example, the same effect as in this embodiment may be obtained even if the first contact portion 542 and the second contact portion 552 are formed as curved surfaces.

In this embodiment, the tray shaft 591 of the tray unit 50 abuts against the third contact portion 562 of the apparatus main body 1A to restrict the excessive insertion of the tray unit 50. However, the configuration is not limited to this. The third contact portion may contact parts other than the tray shaft 591, as long as the function of restricting the excessive insertion of the tray unit 50 is secured and the return portion functions properly.

### Third Embodiment

With reference to FIGS. 9 to 12 and FIG. 16, a method for positioning the tray unit 50 with respect to the apparatus main body 1A according to a third embodiment will be described. In this embodiment, components common to those of the first and second embodiments are denoted by the same reference numerals, and components that differ from those in the first and second embodiments will be mainly described. Matters not specifically described in this embodiment are the same as those in the first and second embodiments.

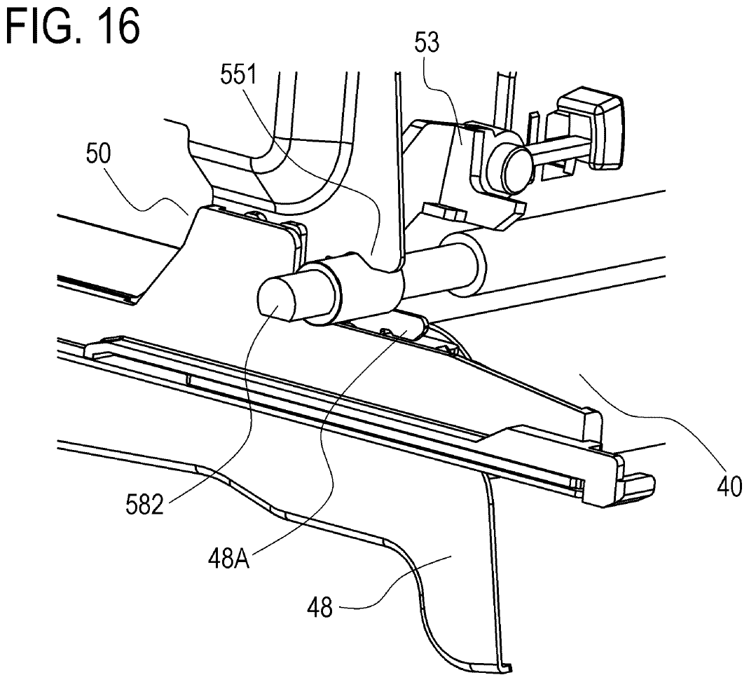

FIG. 16 is a perspective view illustrating the positioning configuration of the tray unit 50 at the tip end side in the insertion direction with respect to the apparatus main body 1A according to this embodiment. The connection shaft 582 is arranged on the second end 1b2 side of the apparatus main body 1A to connect the left side frame 100L and the right side frame 100R. As illustrated in FIG. 16, the connection shaft 582 has a non-circular engagement portion with respect to the right side frame 100R. Specifically, the engagement portion with the right side frame 100R has a so-called D-shape that includes an arc portion and a flat portion (straight portion). That is, the connection shaft 582 is configured not to rotate freely with respect to the right side frame 100R. Note that in FIG. 16, the right side frame 100R is not illustrated. Except for the non-circular engagement portion with the right side frame 100R, the connection shaft 582 has a circular cross section and extends in a direction orthogonal to the movement direction of the tray unit 50.

The other configurations in the third embodiment are the same as those in the first embodiment.

In the third embodiment, the connection shaft 582 is not freely rotatable. Therefore, the same surface of the connection shaft 582 always abuts against the third contact portion 561.

As illustrated in FIGS. 18A and 18B, the connection shaft 582 has the first contacted portion 91 that contacts the first contact portion 541, the second contacted portion 92 that contacts the second contact portion 551, and the third contacted portion 93 that contacts the third contact portion 561. Unless the connection shaft 582 rotates, neither the first contact portion 541 nor the second contact portion 551 contacts the third contacted portion 93, and the third contact portion 561 does not contact both the first contacted portion 91 and the second contacted portion 92.

Accordingly, even if the connection shaft 582 wears due to the repeated pulling-out and attachment of the tray unit 50 or the attachment of the tray unit 50 with an excessive force, the surface of the connection shaft 582 that contacts the first contact portion 541 and the second contact portion 551 is not affected. That is, in the connection shaft 582, the regions that contact the first contact portion 541, the second contact portion 551, and the third contact portion 561 are always different from each other because the rotation of the connection shaft 582 is restricted. Accordingly, even if wear occurs in the region of the connection shaft 582 that contacts the third contact portion 561, the influence on the positioning accuracy of the tray unit 50 may be more reliably suppressed.

In this embodiment, it is only necessary for the connection shaft 582 not to rotate with respect to the left side frame 100L and the right side frame 100R. The configuration that restricts the rotation does not have to involve an engagement portion having a non-circular shape. The non-circular shape is not limited to a D-shape and may have, for example, a plurality of flat portions (a plurality of straight portions).

### Fourth Embodiment

With reference to FIGS. 12 to 15 and FIG. 17, a method for positioning the tray unit 50 with respect to the apparatus main body 1A according to a fourth embodiment will be described. In this embodiment, components common to those of the first to third embodiments are denoted by the same reference numerals, and components that differ from those in the first to third embodiments will be mainly described. Matters not specifically described in this embodiment are the same as those in the first to third embodiments.

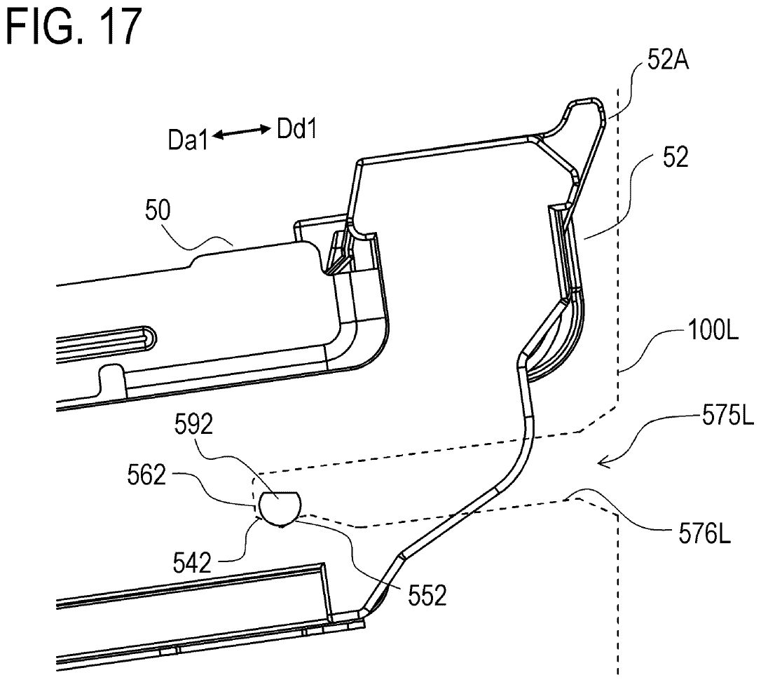

FIG. 17 is a perspective view illustrating the positioning configuration of the tray unit 50 on the rear end side in the insertion direction with respect to the apparatus main body 1A according to this embodiment. The tray shaft 592 that extends outside the left side frame 100L and the right side frame 100R is provided on the side of the tray unit that is closer to the tray handle 52. As illustrated in FIG. 17, the tray shaft 592 has a non-circular engagement portion with respect to the tray unit 50. Specifically, the engagement portion with the tray unit 50 has a so-called D-shape that includes an arc portion and a flat portion (straight portion). That is, the tray shaft 592 is configured not to freely rotate with respect to the tray unit 50.

The other configurations in the fourth embodiment are the same as those in the second embodiment.

In the fourth embodiment, the tray shaft 592 is not freely rotatable. Therefore, the same surface of the tray shaft 592 always abuts against the third contact portion 562.

As illustrated in FIGS. 19A and 19B, the tray shaft 592 has the first contacted portion 91 that contacts the first contact portion 542, the second contacted portion 92 that contacts the second contact portion 552, and the third contacted portion 93 that contacts the third contact portion 562. Unless the tray shaft 592 rotates, neither the first contact portion 542 nor the second contact portion 552 contacts the third contacted portion 93, and the third contact portion 562 does not contact both the first contacted portion 91 and the second contacted portion 92.

Accordingly, even if the tray shaft 592 wears due to the repeated pulling-out and attachment of the tray unit 50 or the attachment of the tray unit 50 with an excessive force, the surface of the tray shaft 592 that contacts the first contact portion 542 and the second contact portion 552 is not affected. That is, in the tray shaft 592, the regions that contact the first contact portion 542, the second contact portion 552, and the third contact portion 562 are always different from each other because the rotation of the tray shaft 592 is restricted. Accordingly, even if wear occurs in the region of the tray shaft 592 that contacts the third contact portion 562, the influence on the positioning accuracy of the tray unit 50 may be more reliably suppressed.

In this embodiment, it is only necessary for the tray shaft 592 not to rotate with respect to the tray unit 50. The configuration that restricts the rotation does not have to involve an engagement portion having a non-circular shape. The non-circular shape is not limited to a D-shape and may have, for example, a plurality of flat portions (a plurality of straight portions).

The respective configurations described in the above embodiments may be combined with each other.

According to the present disclosure, it is possible to suppress the influence on the positioning of the tray with respect to the apparatus main body caused by the deformation of at least one of the engagement portion and the engaged portions.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-156803, filed on Sep. 10, 2024, which is hereby incorporated by reference herein in its entirety.

What is claimed is:

1. An image forming apparatus configured to perform an image forming operation on a recording material, the image forming apparatus comprising:
an apparatus main body;
a pullout portion movable with respect to the apparatus main body in an insertion direction and a pullout direction opposite to the insertion direction, the pullout portion being movable with respect to the apparatus main body to an attachment position, a pullout position located downstream of the attachment position in the pullout direction, and a restricted position located downstream of the attachment position in the insertion direction;
an engagement portion provided on one of the apparatus main body and the pullout portion; and
an engaged portion provided on the other of the apparatus main body and the pullout portion,
wherein
the engaged portion includes
a positioning portion including a first contact portion and a second contact portion, the first contact portion and the second contact portion of the positioning portion being in contact with the engagement portion in a case where the pullout portion is in the attachment position, movement of the pullout portion in the insertion direction is restricted by contact between the first contact portion and the engagement portion, movement of the pullout portion in the pullout direction is restricted by contact between the second contact portion and the engagement portion,
a restriction portion configured to contact the engagement portion to restrict the movement of the pullout portion in the insertion direction in a case where the pullout portion reaches the restricted position, and
a return portion configured to contact the engagement portion in a case where the pullout portion is in the restricted position so that the pullout portion moves from the restricted position to the attachment position under an own weight thereof.

2. The image forming apparatus according to claim 1, wherein
the image forming operation is capable of being performed in a state where the pullout portion is in the attachment position.

3. The image forming apparatus according to claim 2, wherein
the engagement portion includes a first contacted portion configured to contact the first contact portion, a second contacted portion configured to contact the second contact portion, and a third contacted portion configured to contact the restriction portion, and
the first contacted portion, the second contacted portion, and the third contacted portion are arranged at mutually different positions.

4. The image forming apparatus according to claim 1, wherein
the insertion direction is inclined downward from an upstream side toward a downstream side.

5. The image forming apparatus according to claim 4, wherein
movement of the pullout portion in a direction intersecting the insertion direction is restricted by contact of the engagement portion with the first contact portion and the second contact portion.

6. The image forming apparatus according to claim 1, wherein
the engagement portion is restricted from rotating with respect to one of the apparatus main body and the pullout portion.

7. The image forming apparatus according to claim 1, further comprising:
a cartridge that is removably mounted on the pullout portion.

8. The image forming apparatus according to claim 1, wherein,
in a state where the engagement portion is in contact with the return portion, the return portion extends in a direction intersecting both a horizontal direction and a gravity direction.

9. The image forming apparatus according to claim 1, wherein
the pullout portion has the engagement portion, and the apparatus main body has the engaged portion.

10. The image forming apparatus according to claim 9, wherein
the restricted portion is located downstream of the first contact portion and the second contact portion in the insertion direction.

11. The image forming apparatus according to claim 9, wherein
the first contact portion is a first inclined surface, and
the second contact portion is a second inclined surface, and
wherein
a direction in which the first inclined surface extends intersects both a horizontal direction and a gravity direction, and
a direction in which the second inclined surface extends intersects both the horizontal direction and the gravity direction.

12. The image forming apparatus according to claim 9, wherein
the pullout portion has an upstream end and a downstream end in the insertion direction, and the engagement portion is located closer to the upstream end than to the downstream end.

13. The image forming apparatus according to claim 1, wherein
the pullout portion has the engaged portion, and the apparatus main body has the engagement portion.

14. The image forming apparatus according to claim 13, wherein
the restricted portion is located upstream of the first contact portion and the second contact portion in the insertion direction.

15. The image forming apparatus according to claim 13, wherein
the first contact portion is a first inclined surface, and
the second contact portion is a second inclined surface, and
wherein,
in a state where the pullout portion is in the attachment position,
a direction in which the first inclined surface extends intersects both a horizontal direction and a gravity direction, and
a direction in which the second inclined surface extends intersects both the horizontal direction and the gravity direction.

16. The image forming apparatus according to claim 13, wherein
the pullout portion has an upstream end and a downstream end in the insertion direction, and the engagement portion is located closer to the downstream end than to the upstream end.
